(19) United States
(12) Patent Application Publication
(10) Pub. No.: US 2025/0313283 A1
(43) Pub. Date: Oct. 9, 2025

(54) AERODYNAMIC UNDERBODY STRUCTURES, ASSEMBLIES WITH THE SAME, AND METHODS OF MANUFACTURING, INTEGRATING, AND USING THE SAME

(71) Applicant: Daimler Truck North America LLC, Portland, OR (US)

(72) Inventors: Georgeanna ALEMANY, Clackamas, OR (US); Dinesh MADUGUNDI, Beaverton, OR (US); Morris HENRY, Happy Valley, OR (US)

(21) Appl. No.: 18/866,029

(22) PCT Filed: May 18, 2023
(86) PCT No.: PCT/US2023/022769

§ 371 Date: Nov. 14, 2024

Related U.S. Application Data
(60) Provisional application No. 63/343,460, filed on May 18, 2022.

(51) Int. Cl. B62D 35/02; B62D 35/00

(52) U.S. Cl. CPC B62D 35/02; B62D 35/001

(57) ABSTRACT

Aerodynamic underbody structures, assemblies with the same, and methods of manufacturing, integrating, and using the same. To improve the aerodynamic performance of a vehicle, e.g., a truck, such as a tractor-trailer, one or more aerodynamic underbody structures are integrated thereon. The aerodynamic underbody structures can each include an elongated panel (22) that attaches to a mounting structure (18) that attaches to a vehicle underbody, thereby allowing each elongated panel to extend downward into a flow path beneath the vehicle. The elongated panels may extend substantially in parallel, being spaced inward from outer chassis structures, wheels, and/or fairings, or can be angled relative to each other. The configurations and implementations of the aerodynamic components described herein can improve aerodynamic performance of vehicles.

### FIELD OF THE INVENTION

The field relates to aerodynamic vehicle components.

### BACKGROUND OF THE INVENTION

Vehicles, e.g., trucks, such as tractor-trailers, sometimes have large profiles and sometimes transport heavy loads. This, in turn, increases the importance of aerodynamic performance so that power produced by a powertrain, e.g., electric and/or combustion, is effectively translated into forward motion thereby helping to maximize fuel efficiency. The use of aerodynamic structures on exterior vehicle surfaces can be helpful for improving aerodynamic performance.

### SUMMARY OF THE INVENTION

This summary is intended to introduce a selection of concepts in a simplified form that are further described below in the detailed description section of this disclosure. This summary is not intended to identify key or essential features of the claimed subject matter, nor is it intended to be used as an aid in isolation to determine the scope of the claimed subject matter.

In brief, and at a high level, this disclosure describes, among other things, aerodynamic underbody structures, assemblies that include aerodynamic underbody structures, and methods of manufacturing, integrating, and using the same, e.g., in connection with vehicles. The embodiments described herein can be used to improve aerodynamic performance in vehicles including those having various types of powertrains, e.g., combustion, electric, and/or hybrid combustion-electric, among others.

In aspects, a set of aerodynamic underbody structures is provided. In embodiments, an assembly that includes a set of aerodynamic underbody structures is provided. The aerodynamic underbody structures described herein may have different configurations. For example, in an embodiment, aerodynamic underbody structures each include an elongated panel and a mounting structure. The mounting structure may be attachable to the elongated panel, or may otherwise be integrated with the elongated panel. For example, the mounting structure may include an elongated-element that attaches to the elongated panel (e.g., the elongated-element may be an elongated bracket with a recess for receiving/securing at least part of the elongated panel). In embodiments, a mounting structure may include at least one attachment, e.g., elongated-extension that attaches to the elongated-element, used for attaching the mounting structure to a chassis frame rail forming part of a chassis. The attachment may be configured to extend generally perpendicular from the elongated-element to a mounting location on the chassis frame rail. This allows the mounting structure and the associated elongated panel to be attached to a vehicle underbody to thereby introduce an aerodynamic feature that can improve aerodynamic performance. In embodiments, the aerodynamic underbody structures described herein may be located inward of outer chassis elements, e.g., outer aerodynamic fairings installed adjacent to a perimeter of the chassis, and may extend downward from the chassis, e.g., away from a plane extending substantially parallel to a surface of the chassis, and towards a surface on which the vehicle/chassis is resting. In embodiments, elongated panels may extend downward a distance that is less than a distance extended downward by outer chassis elements, e.g., outer aerodynamic fairings. The aforementioned components and configurations, in addition to others described herein, have been demonstrated to improve aerodynamic performance, e.g., by reducing turbulent flow, increasing laminar flow, and/or by limiting or impeding aerodynamically penalizing cross-flow at a vehicle underbody, among other benefits. The embodiments described herein may further provide such benefits with limited complexity, components, and cost, among other benefits.

### BRIEF DESCRIPTION OF THE DRAWING

The aerodynamic underbody structures, assemblies with the same, and methods of manufacturing, integrating, and using the same disclosed herein are described in detail with reference to the attached figures, which illustrate non-limiting embodiments, wherein:

FIG. 1 depicts a set of aerodynamic underbody structures, in accordance with embodiments of the present disclosure;

FIG. 2 depicts another set of aerodynamic underbody structures, in accordance with embodiments of the present disclosure;

FIG. 3 depicts the set of aerodynamic underbody structures shown in FIG. 1 incorporated into an assembly, in accordance with embodiments of the present disclosure;

FIG. 4 is a partially exploded depiction of the assembly shown in FIG. 3, in accordance with embodiments of the present disclosure;

FIG. 5 depicts the set of aerodynamic underbody structures shown in FIG. 2 incorporated into an assembly, in accordance with embodiments of the present disclosure;

FIG. 6 is a partially exploded depiction of the assembly shown in FIG. 5, in accordance with embodiments of the present disclosure;

FIGS. 7A-7C depict different perspectives of different aerodynamic underbody assemblies integrated into a vehicle, in accordance with embodiments of the present disclosure;

FIGS. 8A-8C depict example reinforcing connections suitable for attaching aerodynamic underbody structures to a chassis or other structure, in accordance with embodiments of the present disclosure;

FIG. 9 is a block diagram of a method of integrating a set of aerodynamic underbody structures onto a chassis, e.g., thereby forming part of a vehicle, in accordance with embodiments of the present disclosure;

FIGS. 10A and 10B depict another aerodynamic underbody assembly, in accordance with embodiments of the present disclosure;

FIG. 10C depicts a further aerodynamic underbody assembly, in accordance with embodiments of the present disclosure;

FIG. 11 depicts a block diagram of a method of assembling an aerodynamic underbody assembly, in accordance with embodiments of the present disclosure;

FIG. 12 depicts a generic vehicle that can include different types of powertrains along with an aerodynamic underbody assembly, in accordance with embodiments of the present disclosure; and

FIG. 13 depicts a system that supports and enables adjustment of aerodynamic underbody structures mounted on a vehicle, in accordance with embodiments of the present disclosure.

### DETAILED DESCRIPTION OF THE INVENTION

This detailed description is provided in order to meet statutory requirements. However, this description is not intended to limit the scope of the invention described herein. Rather, the claimed subject matter may be embodied in different ways, to include different steps, combinations of steps, different elements, and/or different combinations of elements, similar to those described herein, and in conjunction with other present or future technologies. Moreover, although the terms “step” and “block” may be used herein to identify different elements of methods employed, the terms should not be interpreted as implying any particular order among or between different elements except when the order is explicitly described.

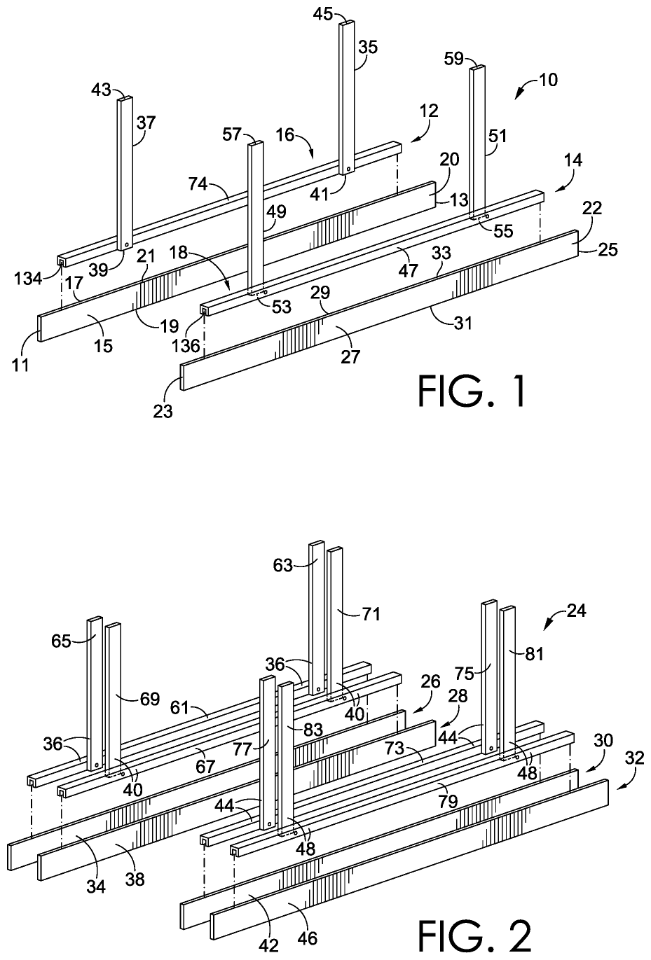

In general, this disclosure describes aerodynamic underbody structures, assemblies that include aerodynamic underbody structures, and methods of manufacturing, integrating, and using the same, e.g., in connection with different types of vehicles, among other things. The embodiments herein may improve vehicle aerodynamic performance and/or fuel efficiency, e.g., by reducing turbulent flow along a vehicle underbody during forward motion, and/or by increasing laminar flow along a vehicle underbody during forward motion, and/or by limiting or impeding aerodynamically penalizing cross-flow along a vehicle underbody during forward motion. The aerodynamic underbody structures discussed herein are represented generically, and may be scaled up or down and/or otherwise modified to impart similar benefits to underbodies and/or vehicles of different sizes, shapes, classes, and configurations. FIGS. 1-13 illustrate non-limiting embodiments of the present subject matter.

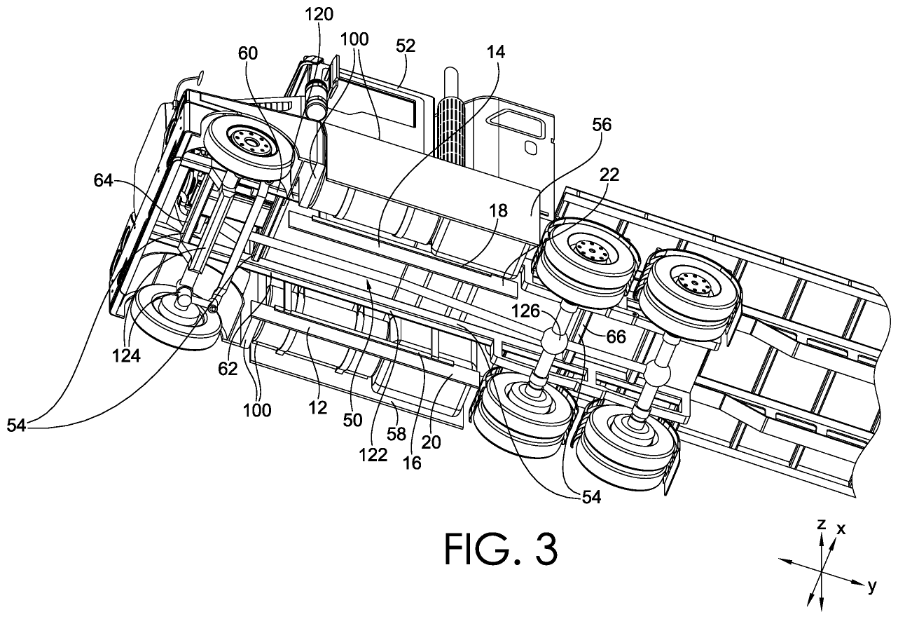

Looking now at FIGS. 1 and 2, separate sets 10, 24 of aerodynamic underbody structures are shown, in accordance with embodiments of the present disclosure. FIG. I depicts a pair of aerodynamic underbody structures. FIG. 2 depicts a set of four aerodynamic underbody structures. FIGS. 1 and 2 are intended to illustrate example configurations. In other embodiments, any number of aerodynamic underbody structures, e.g., such as 1, 2, 3, 4, 5, 6, 7, 8, 9, 10, or more, may be used in similar assemblies.

FIG. 1 depicts a set 10 of aerodynamic underbody structures 12, 14. The aerodynamic underbody structures 12, 14 are configured to be attached to the underbody of a vehicle, e.g., under the chassis frame thereof. The aerodynamic underbody structures 12, 14 shown in FIG. 1 each include a corresponding mounting structure 16, 18 and also each include a corresponding elongated panel 20, 22. The elongated panel 20 includes a panel-end 11, a panel-end 13 opposite from the panel-end 11, a panel-side 15, a panel-side 17 opposite from the panel-side 15, a bottom edge 19, and a top edge 21 opposite from the bottom edge 19. The elongated panel 22 includes a panel-end 23, a panel-end 25 opposite from the panel-end 23, a panel-side 27, a panel-side 29 opposite from the panel-side 27, a bottom edge 31, and a top edge 33 opposite from the bottom edge 31. The elongated panels 20, 22 are each attachable or securable to a corresponding mounting structure 16, 18, shown in FIG. 1. More specifically, the elongated panel 20 is attachable to the mounting structure 16 to form the assembled aerodynamic underbody structure 12, and the elongated panel 22 is attachable to the mounting structure 18 to form the assembled aerodynamic underbody structure 14.

The mounting structure 16 includes an elongated-element 74. The elongated-element 74 is attachable to the elongated panel 20. In particular, the elongated-element 74 is attachable, or securable. proximate the top edge 21 of the elongated panel 20, e.g., at a location within 50% of a distance between the top edge 21 and the bottom edge 19. This attachment may be provided using fasteners (e.g., screws, bolts, anchors, rivets, and the like), brackets, bonding, adhesives, welding, a releasable mechanism (e.g., a tongue-and-groove structure, a latching structure, or a male-female structure, among others), a friction fit, or any combination of the same, and/or through use of other attachment methods suitable for the materials being attached together. In the depicted embodiment, the elongated-element 74 includes a curved-recess 134 that is shaped to receive the top edge 21 of the elongated panel 20.

The attachment of the elongated-element 74 to the elongated panel 20 allows the elongated panel 20 to be retained in a desired position by the mounting structure 16, e.g., in support of an aerodynamic function. To allow for attachment to a chassis, the mounting structure 16 includes a pair of elongated-extensions 35, 37 which are attachable to the elongated-element 74, e.g., at spaced-apart locations, as shown in FIG. 1. While a pair of elongated-extensions 35, 37 are depicted in FIG. 1, in other embodiments, a single elongated-extension of sufficient length to stabilize the elongated panel 20 may be used, or a greater number of elongated-extensions may be used (e.g., a plurality of elongated-extensions may be spaced along a length of the elongated-element 74). In embodiments, the elongated panel 20 can be formed/manufactured from a single solid piece of material. Or, in embodiments, the elongated panel 20 can be formed/manufactured from any number of separate panel portions/pieces that are joined together to form the shape of the elongated panel 20. The separate panel portions/pieces can be attached to a single elongated element similar to the elongated element 74, or the separate panel portions/pieces can be attached to multiple elongated elements each similar to the elongated element 74. In embodiments where separate panel portions/pieces are assembled together, a gap/spacing may exist between the assembled panel portions/pieces. In embodiments, this gap/spacing may be from 0.1 centimeters to about 15 centimeters, among other distances. In embodiments, the number of gaps/spacings in an assembled elongated panel can be based on the number of separate panel portions/pieces assembled together.

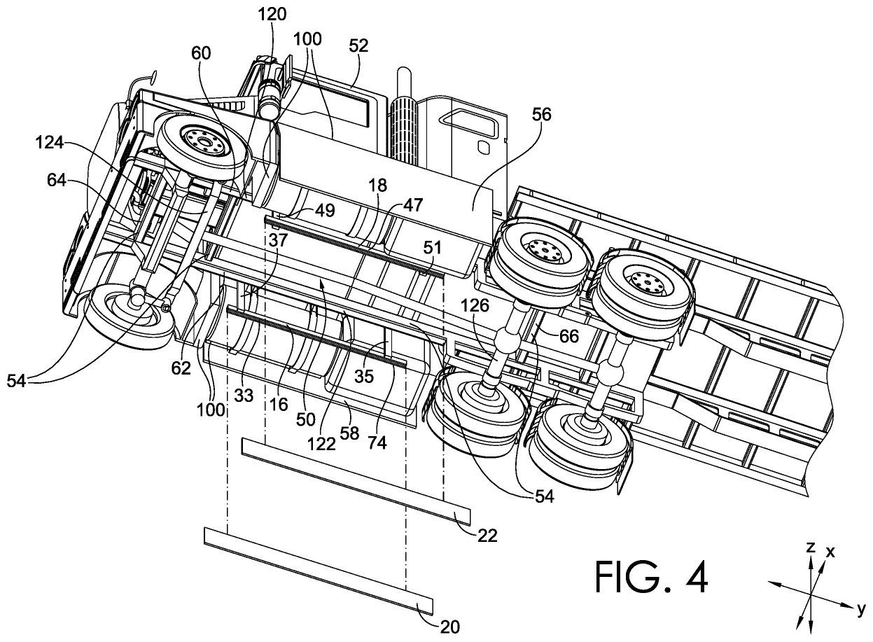

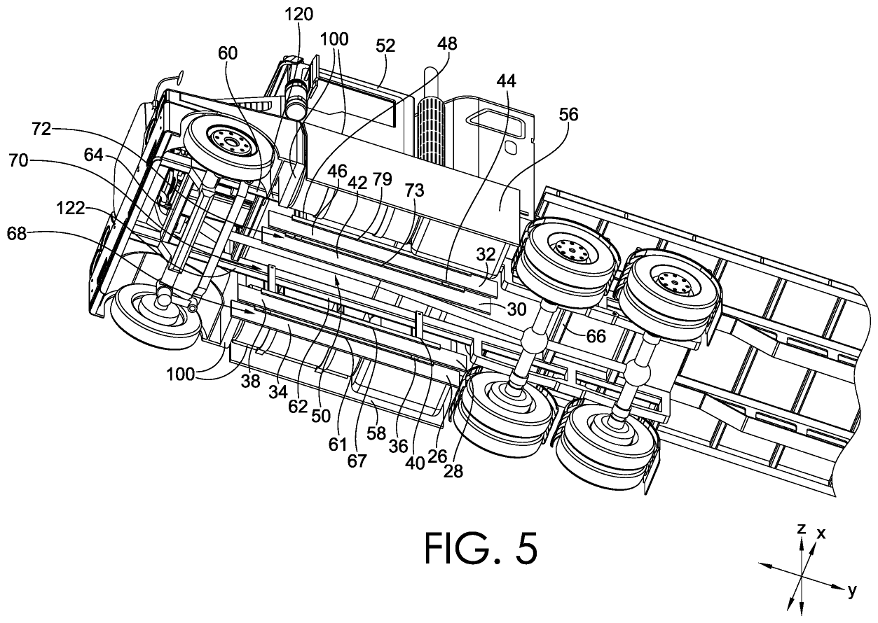

In some embodiments, elongated-extensions, e.g., 35, 37, may attach directly to an elongated panel, e.g., 20, without any elongated-element, e.g., 74, positioned therebetween. In FIG. 1, the elongated-extensions 35, 37 extend from attachment ends 39, 41, which are coupled to the elongated-element 74 at spaced-apart locations, to corresponding attachment-ends 43, 45, configured for attachment to a chassis, e.g., the chassis 54 shown in FIGS. 3-4. The elongated-extensions 35, 37 may be attached to the elongated-element 74 using the methods described above. The elongated-extensions 35, 37 are configured to be attached to the elongated-element 74 substantially perpendicular to a length of the elongated-element 74 (e.g., as measured end-to-end). This orientation allows the elongated-extensions 35, 37 to extend upward to a chassis, where the attachments-ends 43, 45 can be attached/secured to the chassis, thereby anchoring the mounting structure 16 and the elongated panel 20 (or panels or panel pieces) to the chassis, allowing them to impart an aerodynamic function

The mounting structure 18 includes an elongated-element 47. The elongated-element 47 is attachable/securable to the elongated panel 22. In particular, the elongated-element 47 is attachable, or securable, proximate to the top edge 33 of the elongated panel 22, e.g., at a location within 50% of a distance between the top edge 33 and the bottom edge 31. This attachment can be provided using fasteners (e.g., screws, bolts, anchors, rivets, and the like), brackets, bonding, adhesives, welding, a releasable mechanism (e.g., a tongue-and-groove structure, a latching structure, or a male-female structure, among others), a friction fit, or any combination of the same, and/or through use of another attachment method suitable for the materials being attached together. In the depicted embodiment, the elongated-element 47 includes a curved-recess 136 that is shaped to receive/secure the top edge 33 of the elongated panel 22. In embodiments, the elongated panel 22 can be formed/manufactured from a single solid piece of material. Or, in embodiments, the elongated panel 22 can be formed/manufactured from any number of separate panel portions/pieces that are joined together to form the shape of the elongated panel 22. The separate panel portions/pieces can be attached to a single elongated element similar to the elongated element 47, or the separate panel portions/pieces can be attached to multiple elongated elements each similar to the elongated element 47. In embodiments where separate panel portions/pieces are assembled together, a gap/spacing may exist between the assembled panel portions/pieces. In embodiments, this gap/spacing may be from 0.1 centimeters to about 15 centimeters, among other distances. In embodiments, the number of gaps/spacings in an assembled elongated panel can be based on the number of separate panel portions/pieces assembled together.

The attachment of the elongated-element 47 to the elongated panel 22 allows the elongated panel 22 to be retained in a desired position by the mounting structure 18, e.g., to support an aerodynamic function. To provide attachment with a chassis, the mounting structure 18 additionally includes a pair of elongated-extensions 49, 51 which are attachable to the elongated-element 47, e.g., at spaced-apart locations, as shown in FIG. 1. While a pair of elongated-extensions 49, 51 are depicted in FIG. 1, in other embodiments, a single elongated extension of sufficient length to stabilize the elongated panel 22 may be used, or a greater number of elongated-extensions may be used (e.g., a plurality of elongated extensions may be spaced along a length of the elongated panel 22, in embodiments). The elongated-extensions 49, 51 extend from attachment-ends 53, 55, which are coupled to the elongated-element 47, to corresponding attachment-ends 57, 59, which are attachable to a chassis, e.g., the chassis 54 shown in FIGS. 3-4. The elongated-extensions 49, 51 may be attached to the elongated-element 47 using the methods described above. In addition, the elongated-extensions 49, 51 are configured to be attached to the elongated-element 47 substantially perpendicular to a length of the elongated-element 47, e.g., as measured end-to-end. This orientation allows the elongated-extensions 49, 51 to extend upward to a chassis, where the attachment-ends 57, 59 can be attached, and secured, to the chassis, thereby anchoring the mounting structure 18 and the attached elongated panel 22.

The attachment of the mounting structures 16, 18 to a chassis, e.g., the chassis 54 shown in FIGS. 3-4, can be provided using any of the methods described herein, e.g., fasteners (e.g., screws, bolts, anchors, rivets, and the like), brackets, bonding, adhesives, welding, a releasable mechanism (e.g., a tongue-and-groove structure, a latching structure, or a male-female structure, among others), a friction fit, or any combination of the same, and/or through use of another attachment method suitable for the materials being attached together. In addition, each elongated-extension attached to the chassis may utilize at least two spaced-apart points of securement with the chassis, which has been demonstrated to minimize deflection and/or shifting of the components during an aerodynamic operation. In addition, the different elements of the structures 12, 14 shown in FIG. 1 may be formed separately, and then assembled together, as shown in the depicted embodiment. Or, in another embodiment, the elements may be formed integrally, e.g., in unified fashion during a manufacturing process. In another embodiment, some elements may be formed integrally, and others may be formed separately and assembled. The assembled components may be attached using the attachment methods described herein.

Looking now at FIG. 2, another set 24 of aerodynamic underbody structures 26, 28, 30, 32 is provided, in accordance with an embodiment of the present disclosure. FIG. 2 depicts a greater number of such structures than FIG. 1. This multiplied configuration may be suitable for vehicles of larger sizes, and/or with larger aerodynamic profiles, among other applications.

The aerodynamic underbody structure 26 includes an elongated panel 34. The elongated panel 34 is attachable to a mounting structure 36. Similar to FIG. 1, the mounting structure 36 shown in FIG. 2 is represented as an assembly that includes an elongated-element 61 and a pair of elongated-extensions 63, 65 that attach to the elongated-element 61 substantially perpendicular to a length of the elongated-element 61, e.g., measured end-to-end.

The elongated-extensions 63, 65, as with the configuration shown in FIG. 1, are configured to attach the elongated-element 61 to corresponding mounting locations on a chassis, e.g., the chassis 54 shown in FIGS. 3-4.

The aerodynamic underbody structure 28 includes an elongated panel 38. The elongated panel 38 is attachable to a mounting structure 40. Similar to FIG. 1, the mounting structure 40 shown in FIG. 2 is represented as an assembly that includes an elongated-element 67 and a pair of elongated-extensions 69, 71 that attach to the elongated-element 67 substantially perpendicular to a length of the elongated-element 67, e.g., as measured end-to-end. The elongated-extensions 69, 71, as with the configuration shown in FIG. 1, are configured to attach the elongated-element 67 to corresponding mounting locations on a chassis, e.g., the chassis 54 shown in FIGS. 3-4.

The aerodynamic underbody structure 30 includes an elongated panel 42. The elongated panel 42 is attachable to a mounting structure 44. Similar to FIG. 1, the mounting structure 44 shown in FIG. 2 is represented as an assembly that includes an elongated-element 73 and a pair of elongated-extensions 75, 77 that attach to the elongated-element 73 substantially perpendicular to a length of the elongated-element 73, e.g., as measured end-to-end. The elongated-extensions 75, 77, as with the configuration shown in FIG. 1, are configured to attach the elongated-element 73 to corresponding mounting locations on a chassis, e.g., the chassis 54 shown in FIGS. 3-4.

The aerodynamic underbody structure 32 includes an elongated panel 46. The elongated panel 46 is attachable to a mounting structure 48. Similar to FIG. 1, the mounting structure 48 in FIG. 2 is represented as an assembly that includes an elongated-element 79 and a pair of elongated-extensions 81, 83 that attach to the elongated-element 73 substantially perpendicular to a length of the elongated-element 73, e.g., as measured end-to-end. The elongated-extensions 81, 83, as with the configuration shown in FIG. 1, are configured to attach the elongated-element 73 to corresponding mounting locations on a chassis, e.g., the chassis 54 shown in FIGS. 3-4.

The mounting structures 36, 40, 44, 48 can be used to attach/secure the elongated panels 34, 38, 42, 46 to a chassis, e.g., in a substantially fixed or rigid fashion. In embodiments, each elongated panel may be attached to an underbody/chassis frame rail with a corresponding mounting structure. Or, in embodiments, multiple elongated panels may be attached to an underbody/chassis frame rail using a common mounting structure, or a series of common mounting structures. In embodiments, elongated panels may be attached directly to an underbody, without using a mounting structure as depicted in FIGS. 1 and 2, e.g., being attached directly to the chassis using the attachment methods described herein. In embodiments, elongated panels may be integrally formed or manufactured with a vehicle underbody/chassis, rather than being separately formed and attached. In embodiments, each elongated panel 34, 38, 42, 46 can be formed/manufactured from a single solid piece of material, or can be assembled from multiple distinct panel portions/pieces as described herein. In embodiments, each outer panel 34. 46 can be greater in length than the corresponding inner panel 38, 42; each outer panel 34, 46 can be substantially equal in length compared to the corresponding inner panel 38, 42; or each outer panel 34, 46 can be shorter in length than the corresponding inner panel 38, 42.

The aerodynamic underbody structures 12, 14 shown in FIG. 1, and the aerodynamic underbody structures 26, 28, 30, 32 shown in FIG. 2, can be attached to a chassis, e.g., of a vehicle, such as a truck. This allows the elongated panels to be anchored to the chassis, while extending into a fluid path along the underbody, where the panels can impart an aerodynamic function, e.g., during forward motion of a vehicle, and/or during turning/yaw of the vehicle. The aerodynamic underbody structures may accomplish this at least in part by being attached so that the corresponding panels extend along a lengthwise direction of the chassis/vehicle, e.g., substantially in parallel to each other. The lengthwise direction as discussed herein corresponds to an axis extending between a front end of the chassis/vehicle and a rear end of the chassis/vehicle. In addition, the elongated panels may extend substantially in parallel, e.g., such that each is within +/−10 degrees of parallel alignment.

In embodiments, elongated panels discussed herein, including the elongated panels 20, 22 shown in FIG. 1, and the elongated panels 34, 38, 42, 46 shown in FIG. 2, may have different shapes, sizes, and configurations. For example. while each elongated panel depicted in FIGS. 1 and 2 has a rectangular shape, other shapes are contemplated, e.g., different quadrilateral shapes, racetrack shapes, oval shapes, elliptical shapes, or triangular shapes are also contemplated herein. In addition, while each elongated panel depicted in FIGS. 1 and 2 is represented as a single, unified, integral structure, in embodiments, any panel can be formed from multiple structures (e.g., multiple panel pieces/portions that are attached/assembled together to collectively form a single and overall longer elongated panel). In embodiments, the panel portions/pieces can be assembled such that no gap/spacing exists therebetween, or can be assembled such that a gap/spacing exists between the assembled panel pieces/portions. In embodiments, this gap/spacing can be 0.1 centimeters to 15 centimeters.

The elongated panels and components thereof and the mounting structures and components thereof described herein, e.g., including those shown in FIGS. 1 and 2, may be formed or manufactured of different materials that provide suitable material characteristics. For example, in embodiments, the elongated panels may be formed of materials that provide lower stiffness, rigidity, and/or hardness (e.g., those having a relatively lower Young's modulus, or higher modulus of elasticity), compared to the materials of the mounting structures. For example, the elongated panels may be formed of polymer materials and/or polymer composite materials having such material properties. This material selection may facilitate allowing the panels to shift, bend, and/or otherwise elastically deform, e.g., in response to airflow, or in response to impact from objects encountered in an aerodynamic flow path, with reduced likelihood of degradation or dislodgement. In embodiments, the mounting structures and/or components thereof may be formed of materials that provide higher rigidity, stiffness, and/or hardness (e.g., those having a higher Young's modulus, or lower modulus of elasticity), compared to the materials of the elongated panels. This material selection may provide a stronger, more rigid, more reinforcing frame for the elongated panels at their attachment to the chassis or other structure, supporting a more stable aerodynamic operation of the elongated panels. For example, the mounting structures may be formed of metals and/or metal alloys having such material properties. In embodiments, different combinations of the aforementioned materials may be used in components of an aerodynamic underbody assembly, as well. Or, alternatively, all components may be formed of materials having similar or the same material properties, e.g., to support simplified material acquisition and manufacturing. The Young's modulus for the aforementioned materials may be determined using a test method such as ASTM E111-17.

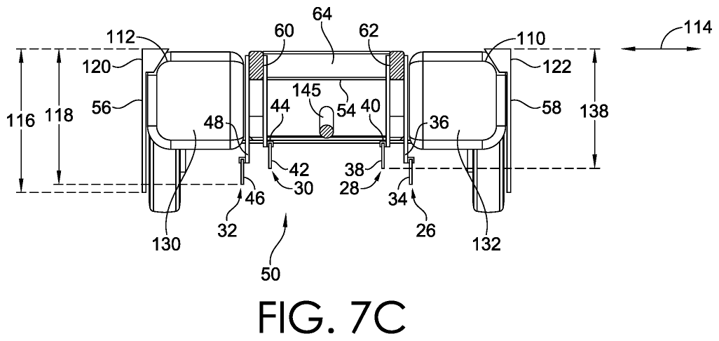

Looking now at FIG. 3, a vehicle 52 is shown, in accordance with an embodiment of the present disclosure. In particular, an underbody 50 of the vehicle 52 is depicted. The underbody 50 includes a chassis 54 and also includes the aerodynamic underbody structures 12, 14 shown in FIG. 1. The aerodynamic underbody structures 12, 14 are mounted to the chassis 54 and/or to other associated structures, e.g., chassis fairings/chassis fairing mounts, and extend lengthwise, and in spaced-apart relation, across the underbody 50, as shown in FIG. 3. In addition, the aerodynamic underbody structures 12, 14 are spaced inward from an outer frame 100 of the chassis 54. The outer frame 100 includes a pair of chassis fairing mounts, which are obscured in FIG. 3 by a pair of fairings 56, 58 coupled to the pair of chassis fairing mounts (shown more clearly in FIG. 7B). The fairings 56, 58 are located on opposite sides 120, 122 of the chassis 54, and impart an aerodynamic profile along the lower-sides of the vehicle 52. The fairings 56, 58 extend generally downward/outward from the corresponding chassis fairing mounts along the z-axis as identified in FIG. 3, and extend generally in parallel with the aerodynamic underbody structures 12, 14 along the y-axis as identified in FIG. 3. In other words, the downward direction is along the z-axis as identified in FIG. 3. generally away from the chassis 54, and towards a surface on which the vehicle 52 would sit, e.g., during operation.

The chassis 54 includes a pair of lengthwise chassis frame rails 60, 62. The lengthwise chassis frame rails 60, 62 are spaced apart from each other, and extend substantially in parallel. The aerodynamic underbody structures 12, 14 are coupled to the lengthwise chassis frame rails 60, 62 at corresponding mounting locations, such that the elongated panels 20, 22 also extend substantially in parallel to each other along the lengthwise direction of the chassis 54, as shown in FIG. 3. The chassis 54 also includes crosswise chassis frame rails 64, 66. The crosswise chassis frame rails 64, 66 are spaced apart from each other, and extend substantially in parallel. The lengthwise chassis frame rails 60, 62 and the crosswise chassis frame rails 64, 66 intersect, forming a frame-like configuration extending around the chassis 54. The outer frame 100 is located outward of the lengthwise chassis frame rails 60, 62, where it supports the chassis fairing mounts (obscured, but an example of which is shown in FIG. 7B) which are coupled to the fairings 56, 58.

The mounting structures 16, 18 are attached to the chassis 54, as most clearly shown in FIG. 4, allowing the elongated panels 20, 22 to extend through the underbody 50, substantially in parallel, and inward of the outer frame 100 and the fairings 56, 58. The size, position, and configuration of the elongated panels 20, 22 (including their length, height, spacing from the fairings 56, 58 along the x-axis, and downward-extending distance from the underbody 50 along the z-axis as identified in FIG. 3) in relation to the size, position, and configuration of the fairings 56, 58 (including their length, height, and downward-extending distance from the underbody 50 along the z-axis as identified in FIG. 3) has been demonstrated to favorably impact aerodynamic performance of the vehicle 52, e.g., during forward motion. In addition, a configuration in which each elongated panel 20, 22, or at least a portion thereof, is spaced at least a distance inward from the adjacent fairing 56, 58, e.g., by at least 15 centimeters, or more, and in which each fairing 56, 58, or at least a portion thereof, extends a distance further downward along the z-axis than the elongated panels 20, 22, e.g., by at least 1-30 centimeters, or more, has been demonstrated to even further favorably impact aerodynamics. These configurations may, during forward motion of the vehicle 52. increase laminar flow through the underbody 50, reduce turbulent flow through the underbody 50, and/or limit or reduce cross-flow through the underbody 50, which in turn, can reduce aerodynamic inefficiency and drag during forward motion.

FIG. 3 also shows the elongated panels 20. 22 extending between a front axle-mount 124 of the chassis 54 and a rear axle-mount 126 of the chassis 54. The elongated panels 20, 22 are mounted such that each starts extending rearward, e.g., toward the rear axle-mount 126, from a location on the chassis 54 that is rearward of the front axle-mount 124, as shown in FIG. 3. This configuration may limit the impact of airflow directed toward the elongated panels 20, 22 at an angle, e.g., by the tires during turning of the vehicle 52, e.g., during vehicle yaw. In additional embodiments, the elongated panels 20, 22 may be shorter, particularly if positioned further inward on the chassis 54, to accommodate the angle of the airflow directed across the underbody 50 when the vehicle 52 is turning, e.g., during vehicle yaw. In other words, positive aerodynamic benefits may be realized with elongated panels positioned further inward on the chassis 54 compared to FIG. 3, when those elongated panels are reduced in length from the forward ends, e.g., the ends closest to the front axle-mount 124, shown in FIG. 3.

Looking now at FIG. 4, an exploded depiction of the assembly shown in FIG. 3 is provided, in accordance with an embodiment of the present disclosure. FIG. 4 shows the shape, length, and profile of the elongated panels 20, 22 in relation to the chassis 54. In addition, FIG. 4 shows the mounting structures 16, 18 in detail, including the elongated-elements 47, 74 thereof which attach to the elongated panels 20, 22. FIG. 4 also shows the elongated-extensions 35, 37 and 49, 51 which secure the corresponding elongated-elements 47, 74 and correspondingly coupled elongated panels 20, 22 to the chassis 54.

The elongated panels 20, 22, and other panels described herein, may be formed from different materials and may be formed using different methods. For example, the elongated panels 20, 22 may be formed of rigid materials, semi-rigid materials, or flexible or semi-flexible materials, or different combinations of the same, in different embodiments. These materials may be formed using different manufacturing processes. For example, a casting process (e.g., metal casting and/or polymer casting), a molding process (e.g., metal molding and/or polymer molding), and/or a machining process (e.g., electrical discharge machining, i.e., “EDM”) may be used to form such materials into panels, e.g., unified panels or multiple-piece assembled panels.

In some embodiments, the elongated panels 20, 22 may be formed of plastics, polymer materials, and/or polymer composites and/or fiber composites. In further instances. the elongated panels 20, 22 may be formed of materials, e.g., polymer-based materials, having a minimum degree of elasticity, e.g., having a Young's modulus equal to or less than 5 gigapascals (GPa), to provide desired material properties, e.g., a degree of flexibility that accommodates natural forces that occur during an aerodynamic flow-guiding operation. In other embodiments, the elongated panels 20, 22 may be formed of materials, e.g., metals, metal alloys, polymers or polymer composites, or natural materials such as wood or wood composites, having a higher degree of rigidity than the aforementioned examples. For example, these materials may have a Young's modulus that is greater than 5 GPa, to provide a desired rigidity or stiffness. These material characteristics may be beneficial for instances where durability is of higher importance. The Young's modulus may be determined using the testing protocol outlined in ASTM E111-17.

The mounting structures 16, 18, and other mounting structures described herein, may be formed from different materials, e.g., those described above, and may be formed using different methods, e.g., those described above. In one instance, the mounting structures 16, 18 may be formed of materials having a relatively higher stiffness, hardness, and/or strength, and a lower elasticity, than the materials forming the elongated panels 20, 22. For example, the mounting structures 16, 18 may be formed of metals, metal alloys, and/or higher-strength polymers and/or higher-strength polymer composites, compared to the materials forming the elongated panels 20, 22. In such configurations, the mounting structures 16, 18 may act like a reinforcing frame, lattice, or structure that supports the elongated panels 20, 22, allowing the elongated panels 20, 22 to more easily deflect or deform when impacted, e.g., by debris, while also maintaining their rigid connection to the chassis, thereby providing beneficial performance attributes.

In embodiments, elongated panels incorporated into an aerodynamic underbody assembly can be formed of materials and/or constructions that provide different stiffness in different areas of the elongated panels. For example, an elongated panel can be formed of materials, combinations of materials, constructions, and/or combinations of constructions, and/or to include reinforcing elements that result in the elongated panel having a higher stiffness in some areas compared to other areas. In an embodiment, a top portion of a panel that attaches to a mounting structure and/or to part of a vehicle (e.g., a chassis frame rail, fuel tank, battery assembly, or the like) may have a higher stiffness than a bottom portion of the panel that is positioned in an aerodynamic flow path. This configuration allows the bottom portion to more easily flex or elastically deform when directing airflow and/or colliding with debris, while also providing rigidity and/or support proximate to attachment and mounting locations.

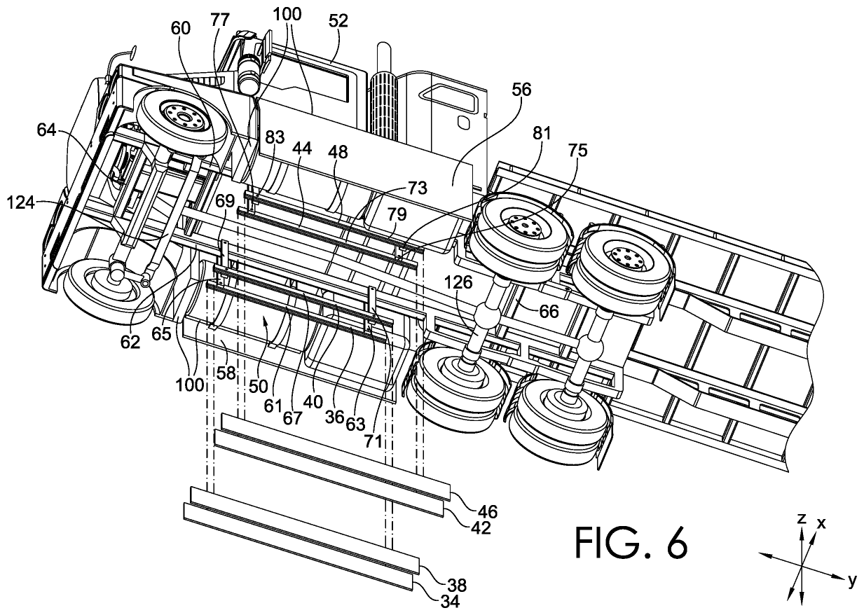

Looking now at FIG. 5, the underbody 50 of the vehicle 52 is again shown, in accordance with an embodiment of the present disclosure. However, FIG. 5 depicts a different configuration, in which the aerodynamic underbody structures 26, 28, 30, 32 shown in FIG. 2 are installed on the underbody 50, instead of the aerodynamic underbody structures 12, 14 shown in FIGS. 1, 3, and 4. This, generally speaking, provides a broader array of aerodynamic structures across the underbody 50. This configuration may be suitable for larger, wider, and/or higher profile vehicles, e.g., those with wider underbodies. The spacing between the aerodynamic underbody structures 26, 28, 30, 32 provides a series of fluid channels 68, 70, 72, which help direct airflow through the underbody 50 during forward motion of the vehicle 52. This, in turn, can help reduce turbulent flow, and increase laminar flow, thereby improving aerodynamic performance. Laminar and turbulent flow, as discussed herein, can be determined from the Reynolds number of the particular flow.

FIG. 5 shows how the aerodynamic underbody structures 26, 28, 30, 32 are located inward from the outer frame 100 of the chassis 54. Like the configuration shown in FIGS. 3 and 4, the elongated panels 34, 38, 42, 46 are spaced inward a distance from the fairings 56, 58, e.g., by at least 1-30 centimeters, or more, e.g., along at least part of a length of the elongated panels 34, 38, 42, 46. In addition, like the configuration shown in FIGS. 3 and 4, the fairings 56, 58 extend downward from the chassis 54 a greater distance than the elongated panels 34, 38, 42, 46, e.g., by at least 1-30 centimeters, or more, e.g., along at least part of a length of the fairings 56, 58. These downward-extending distances may be measured from a common x-y plane extending across the chassis 54, or across another rigid structure, such as the axles or the drive-shaft. In embodiments, the inward spacing is at least 15 centimeters on each side 120, 122. In embodiments, the fairings 56, 58 extend downward at least 15 centimeters further along the z-axis than the elongated panels 34, 38, 42, 46. This spacing configuration has been demonstrated to favorably impact aerodynamics, e.g., by reducing aerodynamic drag during forward motion.

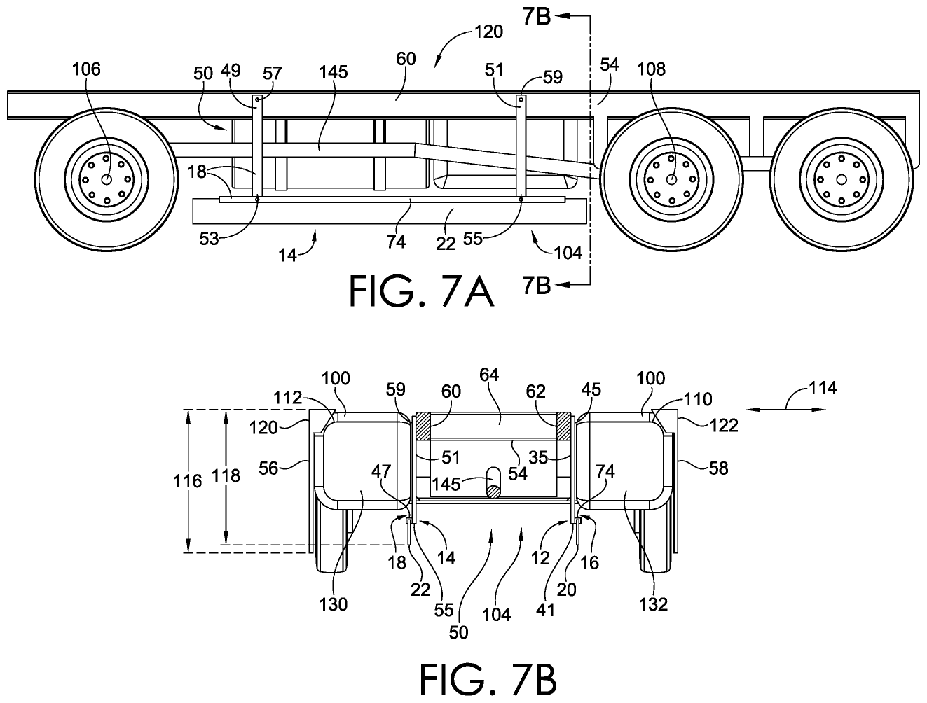

Looking now at FIG. 6, an exploded view of the assembly shown in FIG. 5 is provided, in accordance with an embodiment of the present disclosure. FIG. 6 shows the elongated panels 34, 38, 42, 46 and the associated mounting structures 36, 40, 44, 48 used to attach the elongated panels 34, 38, 42, 46 to the chassis 54. The elongated panels 34, 38, 42, 46 are spaced from the chassis 54 to illustrate the attachment configuration. The elongated panels 34, 38, 42, 46 extend lengthwise under the vehicle 52, e.g., along an axis extending between the front axle-mount 124 and the rear axle-mount 126. In embodiments, the outer elongated panels 34, 46 may be different lengths than the inner elongated panels 38, 42, e.g., being longer so that the inner elongated panels 34, 46 can more easily accommodate crossflows when the vehicle 52 is turning, e.g., is in yaw.

Looking at both FIGS. 5 and 6, it can be seen how the mounting structures 36, 40, 44, 48 are attached to the chassis 54. In particular, the elongated-elements 61, 67, 73, 79 and their corresponding elongated-extensions 63, 65, 69, 71, 75, 77, 81, 83 associated with each mounting structure 36, 40, 44, 48 are attached together, and then the elongated-extensions 63, 65, 69, 71, 75, 77, 81, 83 are attached to the lengthwise chassis frame rails 60, 62 at corresponding mounting locations. This results, as shown in FIGS. 5 and 6, in the assembled set 24 of aerodynamic underbody structures 26, 28, 30, 32 being attached to the chassis 54, with the elongated panels 34, 38, 42, 46 extending into the fluid flow path through/along the underbody 50. It should be noted that a number of numeric elements associated with the set 24 of aerodynamic underbody structures 26, 28, 30, 32 shown in FIG. 2 have been omitted from FIGS. 5 and 6 for clarity purposes. FIGS. 5 and 6 show aerodynamic underbody structures mounted generally to a chassis. However, in embodiments, the structures may additionally or alternatively be mounted to other components and systems attached or supported under the chassis. For example, in embodiments, the aerodynamic underbody structures can be mounted under power generation/transfer components, e.g., motors, engines, axles, differentials, steering columns, and the like, supported under a chassis, and/or can be mounted under power supplies, e.g., batteries, battery arrays, fuel tanks, gas tanks. fuel cells such as hydrogen fuel cells, and the like, e.g., supported by and/or under a chassis.

FIGS. 3-6 depict one example vehicle, e.g., a combustion engine vehicle, e.g., a freight tractor. The aerodynamic underbody structures and assemblies described herein can also be incorporated into other types of vehicles. This includes vehicles that use other types of powertrains. For example, the embodiments herein can be incorporated into electric vehicles, e.g., battery electric vehicles, such as electric trucks. In electric vehicles, the aerodynamic underbody structures and assemblies can be mounted where traditional elements of a combustion powertrain (e.g., engines, fuel tanks, pumps, and the like) might ordinarily be located, but are absent due to the different components used with an electric powertrain. In embodiments associated with an electric vehicle, aerodynamic underbody structures can be mounted under a battery assembly, can be mounted on either side of a battery assembly (e.g., in alignment with front and rear wheels where fuel tanks might traditionally be located), can be mounted under one or more electric motors, axles, or other electric powertrain components, or at other locations. In such configurations, the height of the panel can be adjusted to provide the desired extension from the supporting structure, and/or the mounting structure can be modified to allow for attachment to the supporting structure.

The use of aerodynamic underbody structures in addition to existing externally-mounted aerodynamic features, e.g., outer fairings, has been demonstrated to enhance aerodynamic performance in vehicles, and in particular in larger vehicles, e.g., freight trucks. To state it differently, using aerodynamic underbody structures in addition to externally-mounted (e.g., side-mounted) aerodynamic features along an underbody has been demonstrated to further enhance the aerodynamic benefit provided by externally-mounted aerodynamic features by helping to further control and direct airflow along the underbody. This can be particularly beneficial in larger vehicles where improvements in aerodynamic performance can have a more substantial effect on fuel use and fuel efficiency.

Looking now at FIGS. 7A-7B, different perspectives of an aerodynamic underbody assembly 104 that includes the aerodynamic underbody structures 12, 14 attached to the chassis 54 are provided, in accordance with an embodiment of the present disclosure. FIG. 7A depicts a first perspective of the underbody assembly 104, showing a side view thereof. FIG. 7A, in this sense, depicts the length of the underbody assembly 104. FIG. 7B depicts a second perspective of the underbody assembly 104, showing a rear view thereof. FIG. 7B, in this sense, is oriented perpendicular to the perspective shown in FIG. 7A, and depicts a width of the underbody assembly 104. FIG. 7A shows the aerodynamic underbody structures 12, 14 of the underbody assembly 104 without the fairings 56, 58, for clarity purposes. FIG. 7B shows the underbody assembly 104 with the fairings 56, 58 mounted to the outer frame 100, and specifically to the chassis fairing mounts 110, 112.

FIG. 7A depicts the aerodynamic underbody structure 14 through the side 120. The aerodynamic underbody structure 14 includes the elongated panel 22, which is positioned in a flow path through the underbody 50, and which is attached to the elongated-element 74 that forms part of the mounting structure 18. The elongated-element 74 is further attached to the pair of elongated-extensions 49, 51 which extend generally perpendicular to a length of the elongated-element 74, forming another part of the mounting structure 18. The attachment-ends 53, 55 of the elongated-extensions 49, 51 are attached to the elongated-element 74 and the opposite attachment-ends 57, 59 are attached to corresponding mounting locations on the lengthwise chassis rail 62 forming part of the chassis 54. The attachment of the aforementioned components can be provided using any of the attachment methods described herein. FIG. 7A shows how the elongated panel 22 (and the elongated panel 20 which is obscured) extends downward from the chassis 54, into a space located generally between axles 106, 108. FIG. 7B shows how the underbody structures 12, 14 are mounted such that each extends into a respective space between tanks 130, 132 (e.g., fuel tanks or air tanks) and in addition between the fairings 56, 58.

Looking now at FIG. 7B, the structures 12, 14 are again shown, but looking lengthwise through the underbody 50, in accordance with an embodiment of the present disclosure. FIG. 7B shows how each aerodynamic underbody structure 12, 14 is attached to the chassis 54, e.g., at the lengthwise chassis frame rails 60, 62. In particular, the attachment-ends 45, 59 of the elongated-extensions 35, 51 are attached to the lengthwise chassis frame rails 60, 62, e.g., using any of the attachment methods described herein. The elongated-extensions 35, 51 extend to their corresponding attachments-ends 41, 55, which are attached to the elongated-elements 47, 74, e.g., using any of the attachment methods described herein. FIG. 7B depicts how the elongated-elements 47, 74 each include an elongated recess, e.g., a concave, contoured, and/or c-shaped recess that extends at least part of a length of the elongated-elements 47, 74. This elongated recess allows the elongated-elements 47, 74 to receive the corresponding elongated panel 20, 22, in support of securing the same.

Looking still at FIG. 7B, it can be seen that the elongated-elements 47, 74 are attached proximate to the top edges 21, 33 (omitted in FIG. 7B but identified in FIG. 1) of the corresponding elongated panels 20, 22, thereby securing the elongated panels 20, 22 to the mounting structures 16, 18. In addition, the fairings 56, 58 extend from the outer frame 100, being mounted on corresponding chassis fairing mounts 110, 112. The fairings 56, 58 are spaced outward on the chassis 54 from the structures 12, 14 and their corresponding elongated panels 20, 22, and also extend downward from the chassis 54 generally in parallel with the elongated panels 20, 22. More specifically, the fairings 56, 58 extend downward a distance 116, as measured from the reference plane 114. The elongated panels 20, 22, being installed on the mounting structures 16, 18 that are coupled to the chassis 54, extend downward a distance 118, as measured from the reference plane 114. It can be seen that the distance 118 is shorter than the distance 116. This difference as discussed herein may be 1-30 centimeters, or more, in embodiments. In embodiments, the difference is at least 15 centimeters, a differential demonstrated to favorably impact aerodynamic performance.

In embodiments, the elongated panels, e.g., 20, 22 or 34, 38, 42, 46, may be 5-60 centimeters in height (e.g., as measured from the bottom edge 19 to the top edge 21 of the elongated panel 20 shown in FIG. 1); may be 15-250 centimeters long (e.g., as measured between the panel-end 11 and the panel-end 13 of the elongated panel 20 shown FIG. 1); and/or may be 1-8 centimeters wide (e.g., as measured between the panel-side 15 and the panel-side 17 of the elongated panel 20 shown in FIG. 1).

The reference plane 114 shown in FIG. 7B may be aligned across a top of the chassis 54, along a midline of the chassis 54, or along a bottom of the chassis 54, with the downward distance measurements being based on the same plane location. In other embodiments, the reference plane 114 may instead be located across the top, bottom, or mid-point of the drive shaft, axle, or axle mount, for use in such comparative measurements.

FIG. 7B shows the elongated panels 20, 22 extending generally parallel to each other and generally parallel to a lengthwise direction of the vehicle (e.g., a direction along which a traditional drive shaft would extend). In embodiments, elongated panels, e.g., such as the elongated panels 20, 22 shown in FIG. 7B, may instead be angled relative to each other, may be angled relative to the lengthwise direction (e.g., corresponding to the y-axis shown in FIG. 6), and/or may be angled relative to a vertical direction (e.g., corresponding to the z-axis shown in FIG. 6). In embodiments, panels can be angled 1-30 degrees (e.g., relative to any of the x, y, z axes shown in FIGS. 5 and 6) depending on the desired directionality of the airflow along the underbody. In embodiments, outwardly-mounted panels may be angled more, or less, compared to inwardly-mounted panels. In embodiments where panels are mounted at an angle, the mounting structures may be adapted to support the panels in the angled positions.

Looking now at FIG. 7C, the underbody 50 is again shown, but instead of the set 10 of aerodynamic underbody structures 12, 14 from FIG. 1 being installed on the underbody 50, the set 24 of aerodynamic underbody structures shown in FIG. 2 is installed on the underbody 50, in accordance with an embodiment of the present disclosure. FIG. 7C shows the same perspective as FIG. 7B. FIG. 7C shows the aerodynamic underbody structures 26, 28, 30, 32 installed between the fairings 56, 58 and generally in parallel with the fairings 56, 58 (in other embodiments, the structures 26, 28, 30, 32 may be connected to, mounted on, or otherwise extend from the chassis fairing mounts 110, 112). The corresponding mounting structures 36, 40, 44, 48 are attached to the chassis frame rails 60, 62, e.g., in spaced-apart relation, and the elongated panels 34, 38, 42, 46 are coupled to the mounting structures 36, 40, 44, 48, extending into the aerodynamic flow path at the underbody 50 and extending between the fairings 56, 58.

FIG. 7C also shows a configuration of the elongated panels 34, 38, 42, 46 that provides an aerodynamic benefit. In particular, in FIG. 7C, it can be seen how the elongated panels 34, 38, 42, 46 each extend downward from the chassis 54, i.e., from their respective mounting structures 36, 40, 44, 48. The elongated panels 34, 38, 42, 46 each extend downward, e.g., away from the chassis 54, a distance 118, 138 from the reference plane 114. The fairings 56, 58 also extend downward a distance 116 from the reference plane 114. As shown in FIG. 7C, at least part of a distal edge of each fairing 56, 58 extends downward from the reference plane 114 farther, i.e., a greater distance, than at least part of the distal edges of the elongated panels 34, 38, 42, 46. This difference in downward-extending distance may be 1-30 centimeters, or more, in different embodiments, as discussed herein. In an embodiment, the fairings 56, 58 extending downward at least 1-30 centimeters farther from the reference plane 114 than the elongated panels 34, 38, 42, 46 has been demonstrated to favorably impact aerodynamic performance, e.g., by limiting cross-flow, limiting turbulent flow or non-laminar flow, and by limiting aerodynamic energy losses during forward motion of an associated vehicle. To provide another relative measurement, the fairings 56, 58 may extend downward farther than the elongated panels 34, 38, 42, 46 as measured from a plane extending through the drive shaft 145.

FIG. 7C also depicts how some of the elongated panels 34, 38, 42, 46 extend further downward, e.g., as measured from the reference plane 114, than others. For example, the outer-positioned elongated panels 34, 46 are mounted to the chassis 54 so that each panel 34, 46 extends approximately the distance 118 from the reference plane 114. The inner-positioned elongated panels 38, 42 are mounted to the chassis 54 so that each elongated panel 38, 42 extends downward approximately a distance 138 that is shorter, or less than, the distance 118 as measured from the reference plane 114. Having inwardly-positioned elongated panels, e.g., like the elongated panels 38, 42, terminate at a position closer to the reference plane 114, or to the drive shaft 145, has been demonstrated to favorably impact aerodynamics along the underbody 50. In addition, while not depicted in FIG. 7C, the inward-positioned elongated panels 38, 42 may be shorter in length than the outward-positioned elongated panels 34, 46, e.g., as measured between opposite ends of the elongated panels (e.g., ends 11, 13 of the elongated panel 20 shown in FIG. 1 to provide one example). This has also been demonstrated to favorably impact aerodynamics, e.g., by limiting cross-flow; limiting turbulent flow or non-laminar flow, and by limiting aerodynamic energy losses during forward motion of an associated vehicle.

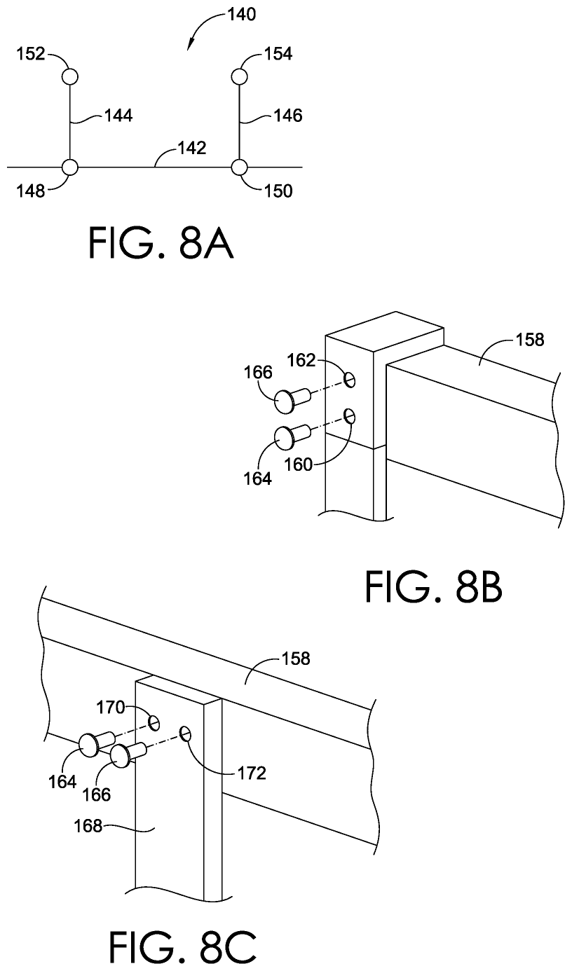

Looking now at FIGS. 8A-8C, different reinforcing configurations used for attaching aerodynamic underbody structures, e.g., the structures 12, 14 shown in FIG. 1, to a chassis, e.g., the chassis 54 shown in FIGS. 3 and 4, are provided, in accordance with embodiments of the present disclosure.

FIG. 8A shows a generically-depicted aerodynamic underbody structure 140. The structure 140 includes a generically-depicted elongated panel 142 (e.g., used to direct fluid-flow during an aerodynamic operation), and a pair of spaced-apart chassis attachments 144, 146. The chassis attachments 144, 146 attach the elongated panel 142 to a chassis, e.g., the chassis 54 shown in FIG. 3. The spaced-apart chassis attachments 144, 146 may be elongated-extensions, e.g., such as the elongated-extensions 35, 37 shown in FIG. 1, among other configurations. FIG. 8A shows how the chassis attachments 144, 146 include a pair of spaced-apart attachment points 148, 150 that attach to the elongated panel 142 and include a pair of spaced-apart attachment points 152, 154 that attach to a chassis, e.g., at corresponding spaced-apart mounting locations (not shown in FIG. 8A). This multi-point connection provided at both the elongated panel 142 and at the chassis is demonstrated to increase stability of the elongated panel 142, e.g., during an aerodynamic operation, e.g., in which fluid pressure is applied to the elongated panel 142 from different directions.

FIGS. 8B-8C depict different reinforcing structures used to attach aerodynamic underbody structures, or mounting structures thereof, to a chassis, in accordance with embodiments of the present disclosure. FIG. 8B shows a bracket 156, e.g., that may be used to connect chassis attachments 144, 146 to a chassis rail 158. The bracket 156 includes a pair of attachments points 160, 162. In the depicted embodiment, fasteners 164, 166 are installed at the attachment points 160, 162, allowing the bracket 156 to be secured to the chassis rail 158. The attachment points 160, 162 provide multiple points of securement, e.g., between the chassis attachments 144, 146 and the chassis rail 158. This is demonstrated to increase stability, limit deflection, and/or limit displacement of connected structures, e.g., elongated panels, during an aerodynamic operation. FIG. 8C shows a similar reinforcing connection. However, in FIG. 8C, a bracket 168 is provided that includes attachment points 170, 172 that are oriented perpendicular relative to the attachment points 160, 162 shown in FIG. 8B. This, once again, provides multiple points of attachment, in this case along a lengthwise direction of the chassis rail 158, instead of along a height-wise direction of the chassis rail 158 as shown in FIG. 8B. This, again, is demonstrated to impart stability, limit deflection, and/or limit displacement of connected structures, e.g., elongated panels, during an aerodynamic operation.

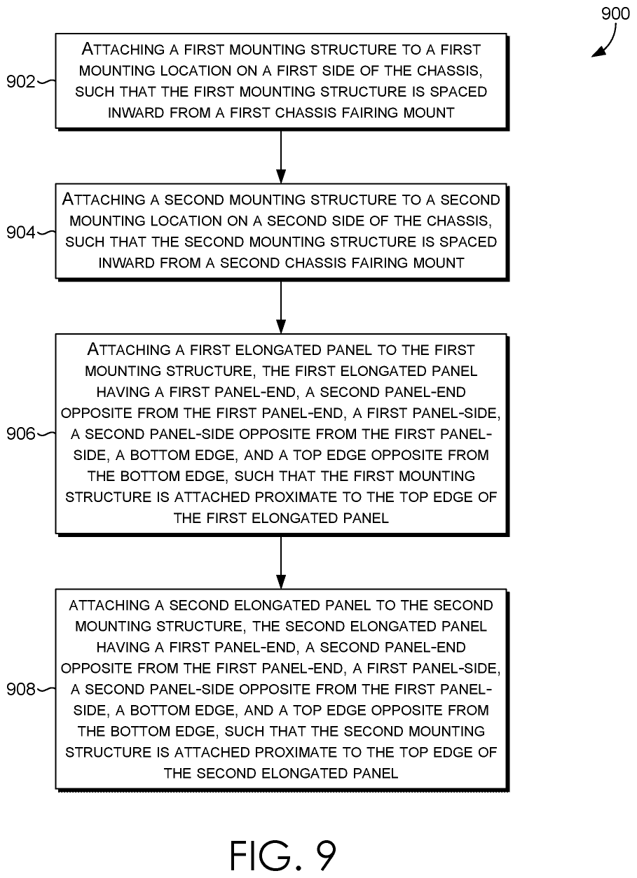

Looking now at FIG. 9, a block diagram of a method 900 of integrating a set of aerodynamic underbody structures, e.g., the structures 12, 14 shown in FIG. 1, into a chassis, e.g., the chassis 54 shown in FIGS. 3-4, the chassis comprising a first side, e.g., the side 120 shown in FIGS. 3-4, having a first chassis fairing mount, e.g., the chassis fairing mount 110 shown in FIG. 7B, and a second side, e.g., the side 122 shown in FIGS. 3-4, having a second chassis fairing mount, e.g., the chassis fairing mount 112 shown in FIG. 7B, is shown, in accordance with an embodiment of the present disclosure.

The method 900 includes blocks 902-908, but is not limited to this combination of elements. In block 902, the method includes attaching a first mounting structure, e.g., the mounting structure 16 shown in FIG. 1, to a first mounting location on the first side of the chassis, such that the first mounting structure is spaced inward from the first chassis fairing mount, e.g., as shown in FIG. 7B. In block 904, the method includes attaching a second mounting structure, e.g., the mounting structure 18 shown in FIG. 1, to a second mounting location on the second side of the chassis, such that the second mounting structure is spaced inward from the second chassis fairing mount. In block 906, the method includes attaching a first elongated panel, e.g., the elongated panel 20 shown in FIG. 1, to the first mounting structure, the first elongated panel having a first panel-end, e.g., the panel-end 11 shown in FIG. 1, a second panel-end, e.g., the panel-end 13 shown in FIG. 1, opposite from the first panel-end, a first panel-side, e.g., the panel-side 15 shown in FIG. 1, a second panel-side, e.g., the panel-side 17 shown in FIG. 1, opposite from the first panel-side, a bottom edge, e.g., the bottom edge 19 shown in FIG. 1, and a top edge, e.g., the top edge 21 shown in FIG. 1, opposite from the bottom edge, such that the first mounting structure is attached proximate to the top edge of the first elongated panel. In block 908, the method includes attaching a second elongated panel, e.g., the elongated panel 22 shown in FIG. 1, to the second mounting structure, the second elongated panel having a first panel-end, e.g., the panel-end 23 shown in FIG. 1, a second panel-end, e.g., the panel-end 25 shown in FIG. 1, opposite from the first panel-end, a first panel-side, e.g., the panel-side 27 shown in FIG. 1, a second panel-side, e.g., the panel-side 29 shown in FIG. 1, opposite from the first panel-side, a bottom edge, e.g., the bottom edge 31 shown in FIG. 1, and a top edge, e.g., the top edge 33 shown in FIG. 1, opposite from the bottom edge, such that the second mounting structure is attached proximate to the top edge of the second elongated panel. The first elongated panel and the second elongated panel extend substantially in parallel along the chassis and between the first chassis fairing mount and the second chassis fairing mount.

In additional contemplated embodiments, a set of aerodynamic underbody structures may be attachable directly or indirectly to an underbody of a vehicle, e.g., to a chassis or frame thereof, without the use of interposed mounting structures. This more-direct attachment may be enabled using any of the methods described herein, e.g., fasteners, bolts, welding, etc. The set of aerodynamic underbody structures may include any number of panels that extend into a fluid path, e.g., in substantially parallel relation, e.g., along a general axis of motion. The panels may be symmetric in shape, or non-symmetric in shape; may be elongated in shape, or non-elongated in shape, and/or may be unified in their construction or assembled from multiple components. The panels may be incorporated into an assembly, e.g., one associated with any number of different vehicles. The panels incorporated into the assembly may be shorter in length, and/or shorter in height, than chassis fairings mounted outwardly on the same assembly. The panels may be the same size, shape, and/or geometry, or different sizes, shapes, and/or geometries, e.g., based on their inward spacing on the assembly (e.g., further-inward spaced panels may be shorter in length and/or height in proportion to their inward distance).

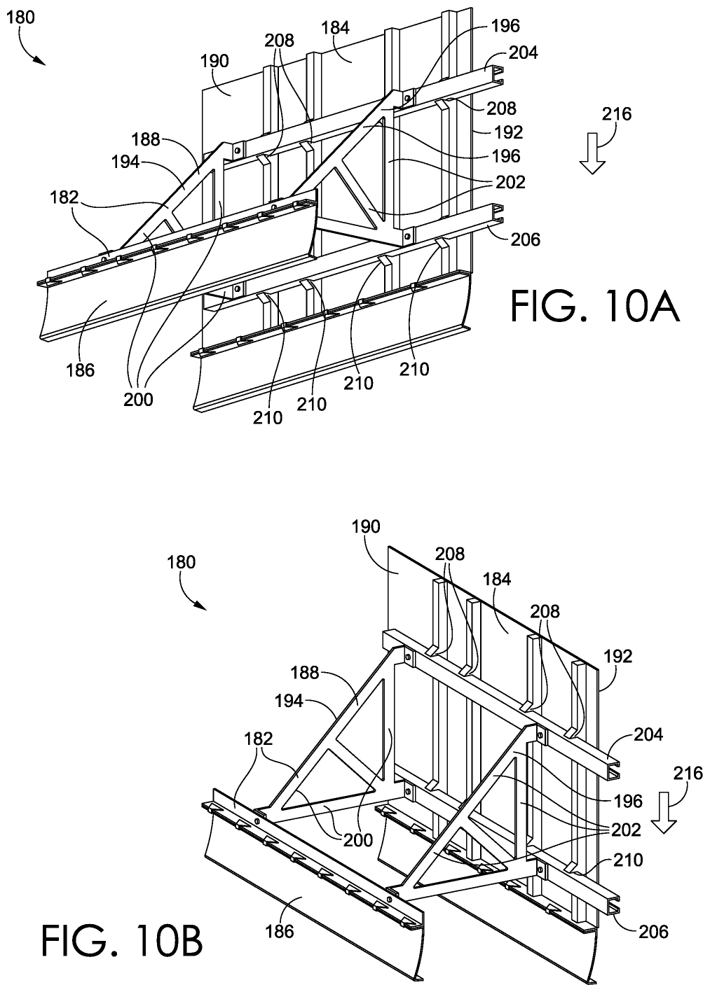

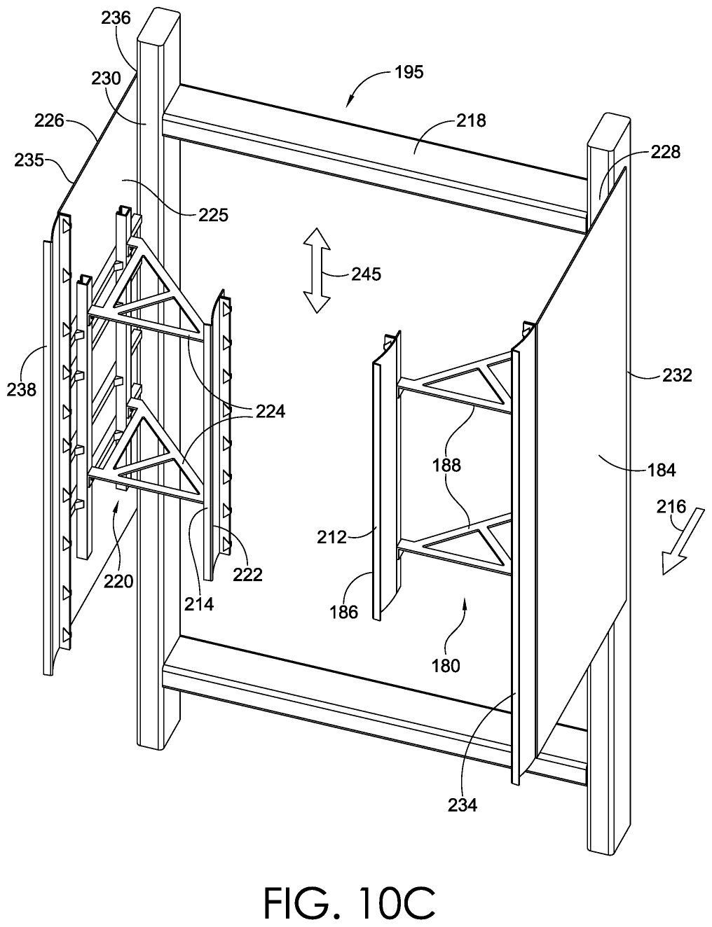

Looking now at FIGS. 10A and 10B, an aerodynamic underbody assembly 180 is shown, in accordance with an embodiment of the present disclosure. FIG. 10A depicts one perspective of the aerodynamic underbody assembly 180. FIG. 10B depicts another perspective of the aerodynamic underbody assembly 180.

The aerodynamic underbody assembly 180 shown in FIGS. 10A and 10B includes an aerodynamic underbody structure 182. The aerodynamic underbody structure 182 is attached to a fairing 184. More specifically, the aerodynamic underbody structure 182 includes an elongated panel 186 that is attached to a mounting structure 188 that is attached to at least the fairing 184, e.g., directly and/or indirectly, according to different embodiments. The fairing 184 is attachable to a chassis or frame, e.g., along a side thereof. In embodiments, the fairing 184 attaches to a chassis fairing mount, e.g., one located at the periphery of a chassis, frame, and/or vehicle underbody. The fairing 184 includes a surface 190 and an opposite-facing surface 192. The surface 190 can form an inner-facing surface, e.g., in an operational or in-use configuration. The surface 192 can form an outer-facing surface, e.g., in an operational or in-use configuration.

The elongated panel 186 may include any of the characteristics described herein for such panels, e.g., being formed of material(s) having at least a degree of elasticity and/or flexibility, and/or having a relative size/position with respect to the fairing 184. The mounting structure 188 may also include any of the characteristics described herein for such structures, e.g., being formed of material(s) having at least a degree of rigidity and/or stiffness, e.g., such as a metal, metal alloy, or composite with such characteristics. In one embodiment, the mounting structure 188 can be formed of material(s) having a higher stiffness and/or rigidity than the material(s) forming the elongated panel 186 and/or the fairing 184. This allows the mounting structure 188 to provide more rigid support/fixation. while simultaneously allowing the elongated panel 186 and/or fairing 184 to provide more accommodating positioning/geometry, e.g., to allow for deflection and displacement, e.g., during airflow channeling, and/or during debris impact, among other instances.

Looking still at FIGS. 10A and 10B, the mounting structure 188 is shown attached to the elongated panel 186 and also attached to the surface 190 of the fairing 184. The mounting structure 188 shown in FIGS. 10A and 10B establishes multiple points of contact that help maintain a substantially fixed positioning of the elongated panel 186 and the fairing 184. In the attached configuration, the elongated panel 186 and the fairing 184 extend substantially in parallel along a lengthwise direction, as shown in FIGS. 10A and 10B. In different embodiments, the attachment of these separate components can be provided using different techniques. For example, the components can be attached using welding, fasteners (e.g., screws, bolts, rivets, and the like), latching elements, male-female structures, tongue-and-groove structures, magnets or magnetic attachments, adhesives, bonding agents, and/or through other techniques.

The mounting structure 188 shown in FIGS. 10A and 10B includes a bracket 194 and a bracket 196. The brackets 194, 196 each attach to the elongated panel 186 at one end (e.g., through one point of attachment) and also each attach to the fairing 184 at the other end (e.g., through two points of attachment). The brackets 194, 196 are mounted in spaced-apart relation, thereby providing multiple points of contact along a lengthwise direction of the elongated panel 186, as shown in FIGS. 10A and 10B. This configuration can enhance stability during an aerodynamic operation, e.g., in which the elongated panel 186 is directing airflow along a chassis/underbody. In the non-limiting embodiment depicted in FIGS. 10A and 10B, the bracket 194 forms a tri-lateral structure 200 (e.g., a frame that includes three sides and/or three points of connection) and the bracket 196 also forms a tri-lateral structure 202 (e.g., a frame that includes three sides and/or three points of connection). This configuration can increase the structural stability of the elongated panel 186 and the fairing 184 by providing multiple points of fixed engagement, and by limiting moment forces and relative movement/rotation. In addition, this configuration can be of particular benefit with fairings formed to have a degree of flexibility and/or elasticity that allows for position/geometry change during operation, e.g., due to airflow pressure or debris impact. The tri-lateral structures 200, 202 can thus operate to more effectively stabilize the components.

The mounting structure 188 also includes a pair of spaced-apart elongated connecting structures 204, 206. The elongated connecting structures 204, 206 attach along the surface 190 of the fairing 184, e.g., being substantially fixed, secured, or mounted thereon or thereto. The brackets 194, 196 are attached to the elongated connecting structures 204, 206, e.g., using any of the techniques described above. The elongated connecting structures 204, 206 are attached to the surface 190 of the fairing 184, e.g., using any of the techniques described above. Thus, in the depicted configuration, the elongated connecting structures 204, 206 are at least partially interposed between the mounting structure 188 and the surface 190 of the fairing 184. The elongated connecting structures 204, 206 can thus help impart greater rigidity between the brackets 194, 196 and the fairing 184, e.g., to limit deflection, limit moment forces, and increase stability. The surface 190 of the fairing 184 also includes a series of recesses 208, 210. The recesses 208, 210 are shaped to at least partially receive the elongated connecting structures 204, 206, thereby helping to increase the stability and securement of their mounting. In an alternative embodiment, the elongated connecting structures 204, 206 may be partially or fully omitted. In such a configuration, the brackets 194, 196 may instead be attached directly to the surface 190 of the fairing 184. In another embodiment, the elongated connecting structures 204, 206 and/or other similar structures may simply extend between the brackets 194, 196 at locations that are spaced from the elongated panel 186 and from the fairing 184. In different embodiments, the brackets 194, 196 and the elongated connecting structures 204, 206 may be integrally formed (e.g., through a common manufacturing process such as molding, casting, or machining), or separately formed as distinct structures, and then assembled.

Looking still at FIGS. 10A and 10B, the elongated panel 186 is attached to the fairing 184 such that when the components are assembled or integrated with a chassis, frame, and/or vehicle underbody, a bottom edge of the fairing 184 extends downward or ground-ward (e.g., as shown by direction 216 in FIGS. 10A and 10B) further than a bottom edge of the elongated panel 186. This distance can be measured perpendicularly from a common horizontal plane extending across the chassis, frame, and/or underbody, or perpendicularly from a common horizontal plane extending across a drive shaft, axel, or other drive-train component, or measured along an axis that extends between the top edge of the fairing 184 and the bottom edge of the fairing 184, in different instances. This differential has again been shown to enhance aerodynamic performance in different operational circumstances.

The embodiment shown in FIGS. 10A and 10B is intended to represent one non-limiting configuration, and other configurations having different components, assemblies, connections, points-of-contact, and relative sizes, positions, and/or orientations are contemplated herein.

Looking now at FIG. 10C, an assembly 195 that includes the aerodynamic underbody assembly 180 and that also includes an aerodynamic underbody assembly 220 is shown, in accordance with an embodiment of the present disclosure. In one aspect, the assemblies 180, 220 may be substantially mirror-images of each other. The assembly 195 is demonstrated to enhance aerodynamic performance, e.g., when included in a vehicle underbody, e.g., through which airflow travels along a lengthwise direction 245. The assembly 195 shown in FIG. 10C includes a chassis 218 (e.g., a frame with frame rails, or portion thereof). The aerodynamic underbody assembly 180 is integrated generally on a first side of the chassis 218. The aerodynamic underbody assembly 220 is integrated generally on a second side of the chassis 218 that is opposite from the first side. The aerodynamic underbody assembly 220 includes an elongated panel 222 that attaches to a mounting structure 224 that attaches to a fairing 226. The fairing 226 includes a surface 225 and an opposite-facing surface 235. The mounting structure 224 attaches the elongated panel 222 to at least the surface 225. The fairing 184 is attached to a chassis fairing mount 228, e.g., one attached to, or forming part of, the chassis 218. The fairing 226 is attached to a chassis fairing mount 230, e.g., one attached to, or forming part of, the chassis 218. In this configuration, the fairings 184, 226 and the elongated panels 186, 222 extend substantially in parallel with each other (e.g., with each being within +/−10 degrees of parallel alignment) along a lengthwise direction 245, as shown in FIG. 10C.

Looking still at the assembly 195 shown in FIG. 10C, the fairing 184 includes a top edge 232 and an opposite bottom edge 234, and the fairing 226 includes a top edge 236 and an opposite bottom edge 238. The elongated panel 186 includes a bottom edge 212. The elongated panel 222 includes a bottom edge 214. In the embodiment depicted in FIG. 10C, the bottom edge 234 of the fairing 184 extends downward or ground-ward (e.g., as indicated by the direction 216 shown in FIG. 10C) further than the bottom edge 212 of the elongated panel 186 attached to the fairing 184, and the bottom edge 238 of the fairing 226 extends downward or ground-ward (e.g., as indicated by the direction 216 shown in FIG. 10C) further than the bottom edge 214 of the elongated panel 222 attached to the fairing 226. This differential in downward or ground-ward extension distance is once again demonstrated to enhance aerodynamic performance, e.g., by directing and/or channeling airflow passing through the assembly 195 along the lengthwise direction 245.

The assemblies 180, 220 are mounted so that the elongated panels 186, 222 extend inward and towards each other, and substantially in parallel, as shown in FIG. 10C. The inward positioning of the elongated panels 186, 222 is also demonstrated to enhance aerodynamic performance, e.g., by directing and/or channeling airflow passing through the assembly 195 along the lengthwise direction 245. In addition, the differential in length of the elongated panels 186, 222 and the fairings 184, 226 along the lengthwise direction 245 is also demonstrated to enhance aerodynamic performance, e.g., by directing and/or channeling airflow passing through the assembly 195 along the lengthwise direction 245.

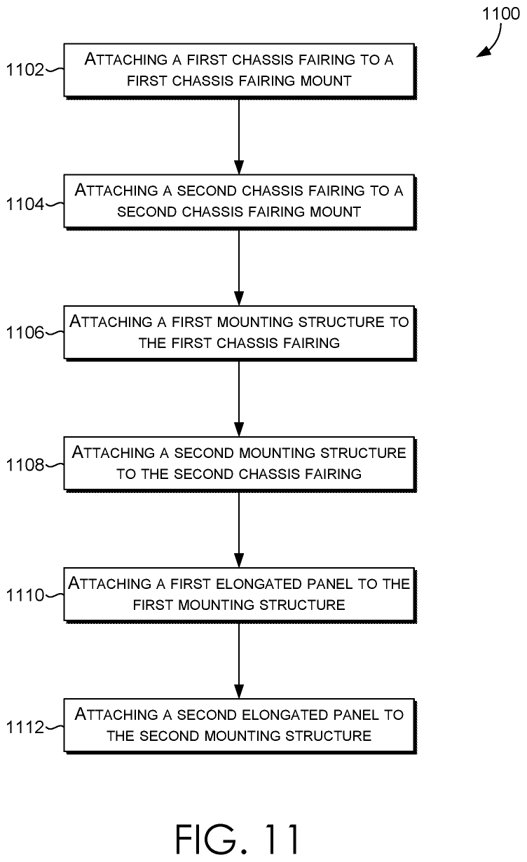

Looking now at FIG. 11, a block diagram of a method 1100 of assembling or integrating an aerodynamic underbody assembly with a chassis, frame, and/or vehicle underbody is provided, in accordance with an embodiment of the present disclosure. The method 1100 includes blocks 1102-1112, but is not limited to this combination of elements. In block 1102, the method includes attaching a first chassis fairing, e.g., the fairing 184 shown in FIG. 10C, to a first chassis fairing mount, e.g., the chassis fairing mount 228 shown in FIG. 10C, the first chassis fairing comprising a first surface, e.g., an inner-facing surface as shown in FIG. 10C, and an opposite-facing second surface, e.g., an outer-facing surface as shown in FIG. 10C. In block 1104, the method includes attaching a second chassis fairing, e.g., the fairing 226 shown in FIG. 10C, to a second chassis fairing mount, e.g., the chassis fairing mount 230 shown in FIG. 10C, the second chassis fairing comprising a first surface, e.g., an inner-facing surface as shown in FIG. 10C, and an opposite second surface, e.g., an outer-facing surface as shown in FIG. 10C. In block 1106, the method includes attaching a first mounting structure, e.g., the mounting structure 188 shown in FIG. 10C, to a first surface of the first chassis fairing, e.g., the inner-facing surface as shown in FIG. 10C. In block 1108, the method includes attaching a second mounting structure, e.g., the mounting structure 224 shown in FIG. 10C, to a first surface of the second chassis fairing, e.g., the inner-facing surface as shown in FIG. 10C. In block 1110, the method includes attaching a first elongated panel, e.g., the elongated panel 186 shown in FIG. 10C, to the first mounting structure. In block 1112, the method includes attaching a second elongated panel, e.g., the elongated panel 222 shown in FIG. 10C, to the second mounting structure.

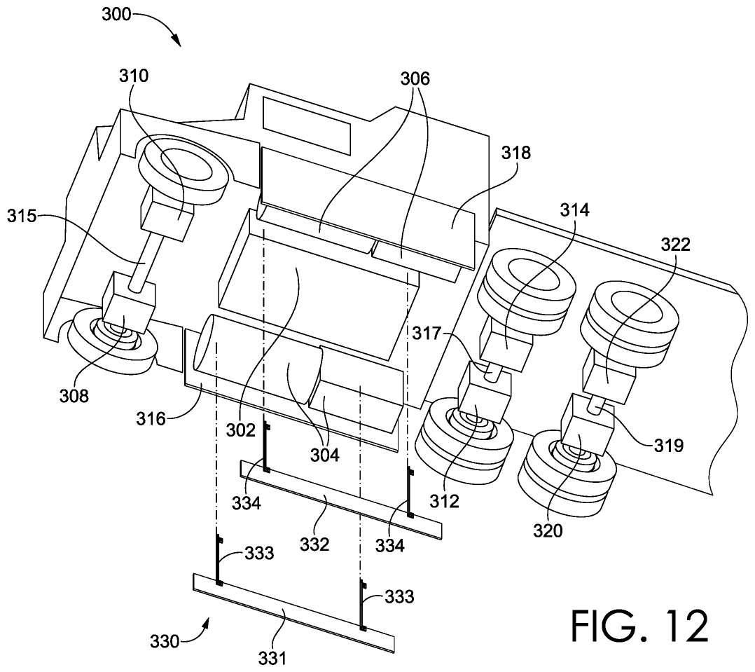

Looking now at FIG. 12, a vehicle 300 is shown, in accordance with embodiments of the present disclosure. The vehicle 300 is depicted in generic form in FIG. 12 for clarity, simplicity, and explanation purposes. The vehicle 300 can include different types of powertrains. For example, in embodiments, the vehicle 300 can be combustion-powered, electric-powered, hybrid combustion-powered and electric-powered, at least partially hydrogen-powered, or powered using another type of powertrain configuration. The vehicle 300 is depicted with a selection of example underbody structures, e.g., structures 302, 304, 306, 308, 310, 312, 314, 315, 317, 319, 320, 322. These structures 302, 304, 306, 308, 310, 312, 314, 315, 317, 319, 320, 322 represent possible components, elements, systems, and/or sub-systems that can be incorporated into the vehicle 300, and used to support operation of the associated powertrain (e.g., combustion, electric, etc.). In embodiments, some of the structures shown in FIG. 12 can be associated with a power source. Power sources can include fuel tanks (e.g., for storing diesel fuel or gasoline), batteries, fuel cells, gas tanks (e.g., for storing natural gas or liquid propane), or the like. In embodiments, such power sources can be incorporated as one or more of the depicted structures 302, 304, 306 shown in FIG. 12. In addition, some structures shown in FIG. 12 can be associated with power generation and/or power transfer, e.g., used to propel the vehicle. These structures can include engines, motors, e.g., combustion motors and electric motors, axles, e.g., passive axles and powered axles, e.g., such as electric axles, as wells as actuators, generators, alternators, or other power generation/transfer components. In embodiments, such power generation and/or power transfer components can be incorporated as one or more of the depicted structures 308, 310, 312, 314, 315, 317, 319, 320, 322 shown in FIG. 12.

FIG. 12 also depicts a non-limiting example of an aerodynamic underbody assembly 330 that can be mounted under the vehicle 300 to impart the aerodynamic benefits described herein. The assembly 330 includes a pair of elongated panels 331, 332 that couple/attach to a pair of mounting structures 333, 334 that couple/attach under the vehicle 300. In embodiments, the assembly 330 and components thereof can be attached to, and supported under, any of the structures 302, 304, 306, 308, 310, 312, 314, 315, 317, 319, 320, 322 shown in FIG. 12. Further, the assembly 330 can be adapted (e.g., adjusted in dimension, adjusted in its configuration used for attachment, and/or adjusted in its length of extension) so that it can be attached to, and supported under, the different structures 302, 304, 306, 308, 310, 312, 314, 315, 317, 319, 320, 322 shown in FIG. 12 while still maintaining clearance from the ground and imparting the desired aerodynamic effect. The assembly 330 can be mounted under the structures 302, 304, 306, 308, 310, 312, 314, 315, 317, 319, 320, and/or 322 such that it is supported in a position that is at least partially inward of externally-mounted aerodynamic structures, e.g., fairings 316, 318 shown in FIG. 12. The assembly 330 includes a pair of elongated panels 331, 332 and corresponding mounting structures 333, 334 in order to illustrate one possible configuration. However, it should be understood that numerous other configurations of such assemblies, e.g., with different numbers, types, and configurations of elongated panels and mounting structures can be implemented in place of what is shown in connection with FIG. 12.

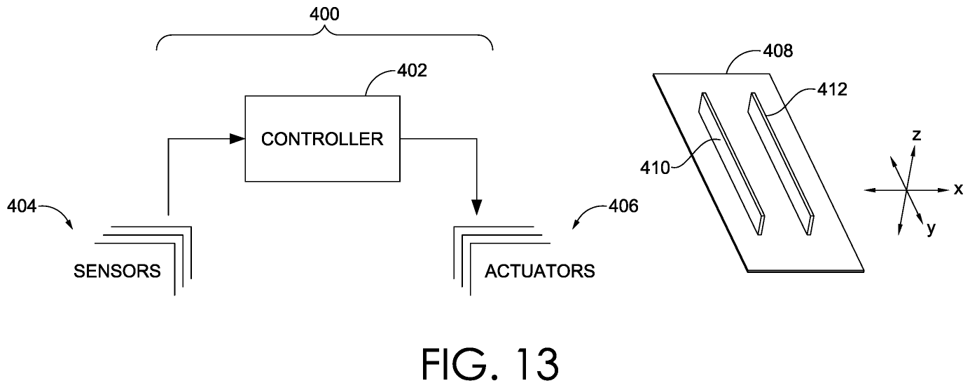

Looking now at FIG. 13, an example configuration that supports operation of an adjustable, e.g., non-fixed or non-static, aerodynamic underbody assembly is shown, in accordance with embodiments of the present disclosure. FIG. 13 in particular depicts a control system 400 and a vehicle assembly 408 that can be used to adjust a position, orientation, and/or configuration of one or more aerodynamic underbody structures installed on a vehicle to impart aerodynamic benefits as described herein. The assembly 408 includes a pair of elongated panels 410, 412 that can be movably coupled to a vehicle underbody, e.g., such that the panels 410, 412 can be at least partially adjusted in position, length, and/or orientation (through operation of attached actuators). FIG. 13 depicts a pair, i.e., two, elongated panels 410, 412 for example purposes. However, in other embodiments, another number, type, configuration, and arrangement aerodynamic panels and assemblies may be implemented in a configuration similar to that shown and described in connection with FIG. 13.

The control system 400 includes a controller 402 that is connected to one or more sensors 404. The controller 402 can receive signals/feedback from the sensors 404 (e.g., signals that indicate a position/orientation of the elongated panels 410, 412, that indicate aerodynamic forces on the elongated panels 410, 412, and/or that indicate an operational state, e.g., speed, of an associated vehicle, in embodiments). The controller 402 is also connected to one or more actuators 406 that can be operated by the controller 402 to change a position of each elongated panel 410, 412 (e.g., a linear position, a rotational position, an extended position, a retracted position, and/or a deployed/non-deployed position). In embodiments, the actuators 406 can be operated by the controller 402 to extend (e.g., lengthen) or retract (e.g., shorten) the panels 410, 412; can be operated by the controller 402 to rotate the panels 410, 412 (e.g., about the y-axis, x-axis, and/or z-axis as indicated in FIG. 13); and/or can be operated by the controller 402 to shift the panels 410, 412 in a linear direction (e.g., along the y-axis, x-axis. and/or z-axis as indicated in FIG. 13). In some embodiments, “retracting” the panel(s) can include adjusting a portion of a panel to adjust its angle so that the adjusted portion does not substantially contribute to aerodynamic effect, thus having the effect of shortening the effective length of the panel. Conversely, in embodiments, “lengthening” the panel(s) can include adjusting a portion of a panel from a position where the portion does not substantially contribute to aerodynamic effect, to another positon where the portion does substantially contribute to aerodynamic effect once it's adjusting is conducted. Other ways of retracting/lengthening a panel are contemplated as within the scope of this disclosure, including but not limited to telescoping (e.g., movement of one part that results in it sliding in or out from another part). The position and/or orientation of the panels 410, 412 can be adjusted, e.g., in response to operational conditions experienced by an associated vehicle. For example, if aerodynamic forces detected and communicated by the sensors 404 indicate that changing a position, orientation, and/or configuration of the panels 410, 412 can improve aerodynamic performance, the controller 402 can in response operate the actuators 406 to change the position/orientation of the panels 410, 412 for more beneficial aerodynamic effect.

The embodiments described herein related to aerodynamic underbody structures, assemblies with the same, and methods of manufacturing, using, and integrating the same may be applicable to a range of vehicle sizes, classes, and types. For example, the aforementioned aspects and embodiments may be used with internal combustion engine (“ICE”) vehicles, electric vehicles (“EV”), battery electric vehicles (“BEV”); hybrid electric vehicles (“HEV”), plug-in hybrid electric vehicles (“PHEV”), or with fuel-cell electric vehicles (“FCEV”), among others.

Clause 1. An underbody assembly for a vehicle, comprising an elongated panel configured to be coupled to a mounting structure that is configured to be coupled to an underbody of the vehicle such that the elongated panel is positioned between wheels located on a first side of the vehicle and wheels located on a second side of the vehicle.

Clause 2. The underbody assembly of clause 1, wherein the vehicle includes a front set of wheels and at least one set of rear wheels, and wherein the elongated panel extends from a first location proximal to the front set of wheels, to a second location proximal to the at least one set of rear wheels.

Clause 3. The underbody assembly of clause 1 or 2, wherein the elongated panel is positioned between the front set of wheels, and the at least one set of rear wheels.

Clause 4. The underbody assembly of any of clauses 1-3, wherein the elongated panel comprises a length between about 0.15 meters and about 3 meters, a height between about 0.05 meters and about 0.8 meters, and a width of about 0.01 meters to about 0.1 meters.

Clause 5. The underbody assembly of any of clauses 1-4, wherein the elongated panel is a single piece.

Clause 6. The underbody assembly of any of clauses 1-5, wherein the elongated panel comprises a plurality of panel portions, and wherein the plurality of panel portions assembled together comprise the length of the elongated panel.

Clause 7. The underbody assembly of any of clauses 1-6, wherein the plurality of panel portions assembled together include a first panel portion and a second panel portion that are spaced apart by a gap.

Clause 8. The underbody assembly of any of clauses 1-7, wherein the elongated panel is positioned at an angle with respect to a vertical axis that extends between a surface that the vehicle rests on and a top of the vehicle.

Clause 9. The underbody assembly of any of clauses 1-8, wherein the angle is 0° to 90°, inclusive, and wherein the elongated panel is positioned substantially parallel to the vertical axis when the angle is 0°.

Clause 10. The underbody assembly of any of clauses 1-9, wherein the angle is 0°.

Clause 11. The underbody assembly of any of claims 1-10, wherein the vehicle includes at least one power source for propelling the vehicle, and wherein the elongated panel is positioned below the at least one power source, such that the elongated panel is positioned between the ground and the at least one power source.

Clause 12. The underbody assembly of any of clauses 1-11, wherein the at least one power source is a tank configured for storing a fluid.

Clause 13. The underbody assembly of any of clauses 1-12, wherein the vehicle has two power sources configured for storing the fluid, the two power sources being a first tank positioned proximal to the wheels located on the first side of the vehicle, and a second tank positioned proximal to the wheels located on the second side of the vehicle, and wherein the elongated panel is positioned substantially between the first storage tank and the second storage tank.

Clause 14. The underbody assembly of any of clauses 1-13, wherein the fluid comprises gasoline, diesel fuel, hydrogen, or natural gas.

Clause 15. The underbody assembly of any of clauses 1-14, wherein the at least one power source comprises one or more batteries configured to power an electric powertrain associated with the vehicle.

Clause 16. The underbody assembly of any of clauses 1-15, wherein the mounting structure is coupled to the one or more batteries, and/or one or more structures that mount the one or more batteries on the vehicle.

Clause 17. The underbody assembly of any of clauses 1-16, wherein the mounting structure is coupled to a chassis frame rail of the vehicle.

Clause 18. The underbody assembly of any of clauses 1-17, wherein the mounting structure is coupled to a fairing.

Clause 19. The underbody assembly of any of clauses 1-18, further comprising two or more of the elongated panels.

Clause 20. The underbody assembly of any of clauses 1-19, wherein the two or more elongated panels are substantially parallel to each other.

Clause 21. The underbody assembly of any of clauses 1-20, wherein the two or more elongated panels extend different distances from the underbody of the vehicle, such that at least one elongated panel is closer to the ground as compared to the other elongated panel.

Clause 22. A vehicle comprising the underbody assembly of any of clauses 1-21.

Clause 23. The vehicle of clause 22, wherein the underbody assembly is a first underbody assembly, and wherein the vehicle comprises a second underbody assembly comprising at least one additional elongated panel configured to couple to another mounting structure on the underbody of the vehicle, such that the at least one additional elongated panel is positioned proximal to rear wheels of the vehicle and extends further toward a rear of the vehicle.

Clause 24. The vehicle of clause 22 or 23, wherein the rear wheels are drive wheels of the vehicle.

Clause 25. The vehicle of any of clauses 22-24, wherein the vehicle is a tractor capable of being removably coupled to a trailer.

Clause 26. A method of mounting an aerodynamic underbody structure on a vehicle, the method comprising: coupling an elongated panel to a mounting structure; and coupling the mounting structure to an underbody of the vehicle, such that the elongated panel extends between wheels located on a first side of the vehicle and wheels located on a second side of the vehicle.

Clause 27. The method of clause 26, wherein the mounting structure is coupled to the underbody before the elongated panel is coupled to the mounting structure, or wherein the elongated panel is coupled to the mounting structure before the mounting structure is coupled to the underbody

Clause 28. The method of clause 26 or 27, wherein the underbody comprises a chassis frame rail, and wherein the mounting structure is coupled to at least the chassis frame rail.

Clause 29. The method of any of clauses 26-28, wherein the underbody comprises an externally-mounted fairing, and wherein the mounting structure is coupled to at least the externally-mounted fairing.

Clause 30. The method of any of clauses 26-29, wherein a power supply is attached to, and supported under, the underbody, and wherein the mounting structure is coupled to the power supply.

Clause 31. The method of any of clauses 26-30, wherein the elongated panel comprises one of a pair of elongated panels that couple in spaced-apart relation between the wheels on the first side and the wheels on the second side, such that the pair of elongated panels are substantially parallel to each other.

Clause 32. The method of any of clauses 26-31, wherein the elongated panel comprises one of a pair of elongated panels that are mounted in spaced-apart relation between the wheels on the first side and the wheels on the second side, such that the pair of elongated panels are positioned at an angle relative to each other.

Clause 33. The method of any of clauses 26-32, wherein the pair of elongated panels are different lengths.

Clause 34. The method of any of clauses 26-33, wherein the pair of elongated panels couple to the underbody such that each extends a different distance from the underbody.

Clause 35. An aerodynamic underbody assembly for a vehicle comprising a chassis comprising a first chassis fairing mount positioned on a first side of the chassis, a second chassis fairing mount positioned on a second side of the chassis, a first mounting location proximate to the first side of the chassis, the first mounting location spaced inward from the first chassis fairing mount, and a second mounting location proximate to the second side of the chassis, the second mounting location spaced inward from the second chassis fairing mount; a first elongated panel having a first panel-end, a second panel-end opposite from the first panel-end, a first panel-side, a second panel-side opposite from the first panel-side, a bottom edge, and a top edge opposite from the bottom edge; a second elongated panel having a first panel-end, a second panel-end opposite from the first panel-end, a first panel-side, a second panel-side opposite from the first panel-side, a bottom edge, and a top edge opposite from the bottom edge; a first mounting structure coupled to the first mounting location, the first mounting structure further coupled to the first elongated panel, such that the first elongated panel extends downward from the first mounting structure; and a second mounting structure coupled to the second mounting location, the second mounting structure further coupled to the second elongated panel, such that the second elongated panel extends downward from the second mounting structure, wherein the first elongated panel coupled to the first mounting structure and the second elongated panel coupled to the second mounting structure extend substantially in parallel and between the first chassis fairing mount and the second chassis fairing mount.

Clause 36. The aerodynamic underbody assembly of clause 35, wherein the chassis further comprises a first lengthwise chassis rail; a second lengthwise chassis rail spaced from the first lengthwise chassis rail; a first crosswise chassis rail extending between the first lengthwise chassis rail and the second lengthwise chassis rail; and a second crosswise chassis rail extending between the first lengthwise chassis rail and the second lengthwise chassis rail and spaced from the first crosswise chassis rail, wherein the first mounting location is on the first lengthwise chassis rail, and wherein the second mounting location is on the second lengthwise chassis rail.

Clause 37. The aerodynamic underbody assembly of clause 35 or 36, further comprising a first chassis fairing coupled to the first chassis fairing mount, the first chassis fairing extending downward a first distance from a reference plane extending across the chassis; and a second chassis fairing coupled to the second chassis fairing mount, the second chassis fairing extending downward a second distance from the reference plane extending across the chassis, wherein the first elongated panel extends downward from the first mounting structure a third distance from the reference plane extending across the chassis, wherein the second elongated panel extends downward from the second mounting structure a fourth distance from the reference plane extending across the chassis, wherein the first distance is greater than the third distance, and wherein the second distance is greater than the fourth distance.

Clause 38. The aerodynamic underbody assembly of any of clauses 35-37, wherein the first distance is at least six inches greater than the third distance, and wherein the second distance is at least six inches greater than the fourth distance.

Clause 39. The aerodynamic underbody assembly of any of clauses 35-38, wherein the first elongated panel is spaced inward at least 6 inches from the first chassis fairing along at least part of a length of the first elongated panel, and wherein the second elongated panel is spaced inward at least 6 inches from the second chassis fairing along at least part of a length of the second elongated panel.

Clause 40. The aerodynamic underbody assembly of any of clauses 35-39, wherein a length of the first elongated panel measured end-to-end is less than a length of the first chassis fairing measured end-to end, and wherein a length of the second elongated panel measured end-to-end is less than a length of the second chassis fairing measured end-to-end.

Clause 41. The aerodynamic underbody assembly of any of clauses 35-40, wherein the chassis further comprises a front axle-mount and a rear axle-mount, and wherein the first elongated panel and the second elongated panel are mounted rearward of the front axle-mount.

Clause 42. The aerodynamic underbody assembly of any of clauses 35-41, wherein substantially in parallel comprises the first elongated panel and the second elongated panel each being within +/−10 degrees of parallel alignment.

Clause 43. The aerodynamic underbody assembly of any of clauses 35-42, wherein the first mounting structure is formed of a material having a higher degree of stiffness than a material forming the first elongated panel, and wherein the second mounting structure is formed of a material having a higher degree of stiffness than a material forming the second elongated panel.

Clause 44. A set of aerodynamic underbody structures mountable to a chassis between a pair of chassis fairing mounts spaced outward on the chassis, the set of aerodynamic underbody structures comprising a first elongated panel having a first panel-end, a second panel-end opposite from the first panel-end, a first panel-side, a second panel-side opposite from the first panel-side, a bottom edge, and a top edge opposite from the bottom edge; a second elongated panel having a first panel-end, a second panel-end opposite from the first panel-end, a first panel-side, a second panel-side opposite from the first panel-side, a bottom edge, and a top edge opposite from the bottom edge; a first mounting structure that is attachable to the first elongated panel proximate the top edge of the first elongated panel, such that the first elongated panel extends outward from the first mounting structure, the first mounting structure further comprising a first pair of spaced-apart chassis attachments; and a second mounting structure that is attachable to the second elongated panel proximate the top edge of the second elongated panel, such that the second elongated panel extends outward from the second mounting structure, the second mounting structure further comprising a second pair of spaced-apart chassis attachments, wherein the first mounting structure with the first elongated panel attached thereto is attachable to the chassis using the first pair of spaced-apart chassis attachments, and wherein the second mounting structure with the second elongated panel attached thereto is attachable to the chassis using the second pair of spaced-apart chassis attachments, such that the first elongated panel and the second elongated panel extend substantially in parallel along the chassis and between the pair of chassis fairings mounts.

Clause 45. The set of aerodynamic underbody structures of clause 44, wherein the first mounting structure is formed of a material having a higher degree of stiffness than a material forming the first elongated panel, and wherein the second mounting structure is formed of a material having a higher degree of stiffness than a material forming the second elongated panel.

Clause 46. The set of aerodynamic underbody structures of clause 44 or 45, wherein the first mounting structure is formed of a metal and/or a metal alloy, wherein the second mounting structure is formed of a metal and/or a metal alloy, wherein the first elongated panel is formed of a polymer material and/or a polymer composite material, and wherein the second elongated panel is formed of a polymer material and/or a polymer composite material.

Clause 47. The set of aerodynamic underbody structures of any of clauses 44-46, wherein the first mounting structure comprises a first elongated-element that is attachable to the first elongated panel proximate the top edge of the first elongated panel to thereby secure the first elongated-element to the first elongated panel, and wherein the second mounting structure comprises a second elongated-element that is attachable to the second elongated panel proximate the top edge of the second elongated panel to thereby secure the second elongated-element to the second elongated panel.

Clause 48. The set of aerodynamic underbody structures of any of clauses 44-47, wherein the first elongated-element comprises an elongated recess shaped to receive at least part of the top edge of the first elongated panel, and wherein the second elongated-element comprises an elongated recess shaped to receive at least part of the top edge of the second elongated panel.

Clause 49. The set of aerodynamic underbody structures of any of clauses 44-48, wherein the first mounting structure further comprises a first pair of elongated-extensions attached to the first elongated-element in spaced-apart relation, wherein the first pair of elongated-extensions each comprise a first attachment-end and an opposite second attachment-end, the first attachment-end attached to the first elongated-element, and the second attachment-end attachable to the chassis, and wherein the second mounting structure further comprises a second pair of elongated-extensions that are attached to the second elongated-element in spaced-apart relation, wherein the second pair of elongated-extensions each comprise a first attachment-end and an opposite second attachment-end, the first attachment-end attached to the second elongated-element, and the second attachment-end attachable to the chassis.

Clause 50. The set of aerodynamic underbody structures of any of clauses 44-49, wherein the second attachment-ends of the first pair of elongated-extensions each include at least two points of securement to the chassis, and wherein the second attachment-ends of the second pair of elongated-extensions each include at least two points of securement to the chassis.

Clause 51. The set of aerodynamic underbody structures of any of clauses 44-50, wherein the second attachment-ends of the first pair of elongated-extensions each comprise a bracket having at least two fastener-receiving apertures, and wherein the second attachment-ends of the second pair of elongated-extensions each comprise a bracket having at least two fastener-receiving apertures.

Clause 52. The set of aerodynamic underbody structures of any of clauses 44-51, wherein substantially in parallel comprises the first elongated panel and the second elongated panel each being within +/−10 degrees of parallel alignment.

Clause 53. A method of integrating a set of aerodynamic underbody structures with a chassis having a first side with a first chassis fairing mount and a second side with a second chassis fairing mount, the method comprising attaching a first mounting structure to a first mounting location on the first side of the chassis, such that the first mounting structure is spaced inward from the first chassis fairing mount; attaching a second mounting structure to a second mounting location on the second side of the chassis, such that the second mounting structure is spaced inward from the second chassis fairing mount; attaching a first elongated panel to the first mounting structure, the first elongated panel having a first panel-end, a second panel-end opposite from the first panel-end, a first panel-side, a second panel-side opposite from the first panel-side, a bottom edge, and a top edge opposite from the bottom edge, such that the first mounting structure is attached proximate to the top edge of the first elongated panel; and attaching a second elongated panel to the second mounting structure, the second elongated panel having a first panel-end, a second panel-end opposite from the first panel-end, a first panel-side, a second panel-side opposite from the first panel-side, a bottom edge, and a top edge opposite from the bottom edge, such that the second mounting structure is attached proximate to the top edge of the second elongated panel, such that the first elongated panel and the second elongated panel extend substantially in parallel along the chassis and between the first chassis fairing mount and the second chassis fairing mount.

Clause 54. The method of clause 53, further comprising attaching a first chassis fairing to the first chassis fairing mount, such that the first chassis fairing and the first elongated panel extend substantially in parallel along the chassis, wherein at least part of the first elongated panel is spaced inward on the chassis from the first chassis fairing by at least six inches; and attaching a second chassis fairing to the second chassis fairing mount, such that the second chassis fairing and the second elongated panel extend substantially in parallel along the chassis, wherein at least part of the second elongated panel is spaced inward on the chassis from the second chassis fairing by at least six inches, wherein the first chassis fairing extends downward from the chassis at least six inches further than the first elongated panel, and wherein the second chassis fairing extends downward from the chassis at least six inches further than the second elongated panel.

Clause 55. A method of manufacturing a set of aerodynamic underbody structures for a vehicle, the method comprising forming a first elongated panel having a first panel-end, a second panel-end opposite from the first panel-end, a first panel-side, a second panel-side opposite from the first panel-side, a bottom edge, and a top edge opposite from the bottom edge; forming a second elongated panel having a first panel-end, a second panel-end opposite from the first panel-end, a first panel-side, a second panel-side opposite from the first panel-side, a bottom edge, and a top edge opposite from the bottom edge; forming a first mounting structure adapted to be secured proximate the top edge of the first elongated panel so that the first elongated panel extends outward from the first mounting structure; and forming a second mounting structure adapted to be secured proximate the top edge of the second elongated panel so that the second elongated panel extends outward from the second mounting structure, wherein the first mounting structure and the attached first elongated panel and the second mounting structure and the attached second elongated panel are attachable to the chassis substantially in parallel to each other.

Clause 56. A set of aerodynamic underbody structures for a vehicle comprising a first panel having a first panel-end, a second panel-end opposite from the first panel-end, a first panel-side, a second panel-side opposite from the first panel-side, a bottom edge, and a top edge opposite from the bottom edge; a second panel having a first panel-end, a second panel-end opposite from the first panel-end, a first panel-side, a second panel-side opposite from the first panel-side, a bottom edge, and a top edge opposite from the bottom edge, wherein the first panel is attachable to a first mounting location on a chassis of the vehicle, and wherein the second panel is attachable to a second mounting location on the chassis of the vehicle, such that the first panel and the second panel that are attached to the chassis extend substantially in parallel to each other.

Clause 57. The set of aerodynamic underbody structures of clause 56, wherein the first panel and the second panel each comprise an elongated shape.

Clause 58. The set of aerodynamic underbody structures of clause 56 or 57, wherein the first panel and the second panel each comprise a single, integrally formed component, or multiple components that are assembled together.

Clause 59. The set of aerodynamic underbody structures of any of clauses 56-58, further comprising at least one mounting structure that attaches the first panel and/or the second panel to the chassis, wherein the first panel and the second panel comprise a higher degree of elasticity than the at least one mounting structure.

Clause 60. A set of aerodynamic underbody structures for a vehicle comprising a first elongated panel having a first panel-end, a second panel-end opposite from the first panel-end, a first panel-side, a second panel-side opposite from the first panel-side, a bottom edge, and a top edge opposite from the bottom edge; a second elongated panel having a first panel-end, a second panel-end opposite from the first panel-end, a first panel-side, a second panel-side opposite from the first panel-side, a bottom edge, and a top edge opposite from the bottom edge; a first mounting structure adapted to be secured proximate to the top edge of the first elongated panel so that the first elongated panel extends outward from the first mounting structure; and a second mounting structure adapted to be secured proximate to the top edge of the second elongated panel so that the second elongated panel extends outward from the second mounting structure, wherein the first mounting structure with the first elongated panel secured thereto is attachable to a first mounting location on a chassis of the vehicle, and wherein the second mounting structure with the second elongated panel secured thereto is attachable to a second mounting location on the chassis of the vehicle, such that the first elongated panel and the second elongated panel that are attached to the chassis extend substantially in parallel.

Clause 61. An aerodynamic underbody assembly for a vehicle comprising a chassis fairing comprising a first surface, and a second surface facing opposite from the first surface; an elongated panel having a first panel-end, a second panel-end opposite from the first panel-end, a first panel-side, a second panel-side opposite from the first panel-side, a bottom edge, and a top edge opposite from the bottom edge; and a mounting structure that attaches the elongated panel to at least the first surface of the chassis fairing, such that the elongated panel and the chassis fairing extend substantially in parallel.

Clause 62. The aerodynamic underbody assembly of clause 61, wherein the

mounting structure comprises a first bracket comprising at least a first end and a second end, wherein the first end of the first bracket couples to the elongated panel, and wherein the second end of the first bracket couples to the chassis fairing; and a second bracket comprising at least a first end and a second end, wherein the first end of the second bracket couples to the elongated panel, and wherein the second end of the second bracket couples to the chassis fairing.

Clause 63. The aerodynamic underbody assembly of clause 61 or 62, wherein the first bracket and the second bracket comprise distinct structures that attach separately between the elongated panel and the chassis fairing.

Clause 64. The aerodynamic underbody assembly of any of clauses 61-63, wherein the first bracket and the second bracket are interconnected by at least one elongated connecting structure that extends between the first bracket and the second bracket.

Clause 65. The aerodynamic underbody assembly of any of clauses 61-64, wherein the first surface of the chassis fairing comprises at least one recess shaped to receive the at least one elongated connecting structure.

Clause 66. The aerodynamic underbody assembly of any of clauses 61-65, wherein the at least one elongated connecting structure comprises a pair of elongated connecting structures that extend between the first bracket and the second bracket in spaced-apart relation, the pair of elongated connecting structures attached along the first surface of the chassis fairing, such that the pair of elongated connecting structures are interposed between the first bracket and the chassis fairing and between the second bracket and the chassis fairing.

Clause 67. The aerodynamic underbody assembly of any of clauses 61-66, wherein the first bracket comprises a first tri-lateral bracket with three points of attachment, and wherein the second bracket comprises a second tri-lateral bracket with three points of attachment.

Clause 68. The aerodynamic underbody assembly of any of clauses 61-67, wherein the first tri-lateral bracket includes one point of attachment for the elongated panel, and two points of attachment for the pair of elongated connecting structures, and wherein the second tri-lateral bracket includes one point of attachment for the elongated panel, and two points of attachment for the pair of elongated connecting structures.

Clause 69. The aerodynamic underbody assembly of any of clauses 61-68, wherein the mounting structure has a higher degree of stiffness than the elongated panel and the chassis fairing, and wherein substantially in parallel comprises being within +/−10 degrees of parallel alignment.

Clause 70. The aerodynamic underbody assembly of any of clauses 61-69, wherein the chassis fairing comprises a top edge and an opposite bottom edge, and wherein, when the elongated panel is attached to the chassis fairing with the mounting structure, the bottom edge of the chassis fairing extends further than the bottom edge of the elongated panel as measured along an axis that extends between the top edge of the chassis fairing and the bottom edge of the chassis fairing.

Clause 71. An aerodynamic underbody assembly for a vehicle comprising a chassis comprising a first chassis fairing mount proximate a first side of the chassis, and a second chassis fairing mount proximate a second side of the chassis; a first chassis fairing, comprising a first surface, and a second surface facing opposite from the first surface; a second chassis fairing, comprising a first surface, and a second surface facing opposite from the first surface, the first chassis fairing attachable to the first chassis fairing mount and the second chassis fairing attachable to the second chassis fairing mount such that the first chassis fairing and the second chassis fairing extend substantially in parallel, and such that the first surface of the first chassis fairing and the first surface of the second chassis fairing face substantially towards each other; a first elongated panel having a first panel-end, a second panel-end opposite from the first panel-end, a first panel-side, a second panel-side opposite from the first panel-side, a bottom edge, and a top edge opposite from the bottom edge; a first mounting structure that attaches the first elongated panel to at least the first surface of the first chassis fairing, such that the first elongated panel and the first chassis fairing extend substantially in parallel; a second elongated panel having a first panel-end, a second panel-end opposite from the first panel-end, a first panel-side, a second panel-side opposite from the first panel-side, a bottom edge, and a top edge opposite from the bottom edge; and a second mounting structure that attaches the second elongated panel to at least the first surface of the second chassis fairing, such that the second elongated panel and the second chassis fairing extend substantially in parallel.

Clause 72. The aerodynamic underbody assembly of clause 71, wherein the first chassis fairing further comprises a top edge and an opposite bottom edge, and wherein, when the first elongated panel is attached to the first chassis fairing with the first mounting structure, the bottom edge of the first chassis fairing extends further than the bottom edge of the first elongated panel as measured along an axis that extends between the top edge of the first chassis fairing and the bottom edge of the first chassis fairing, and wherein the second chassis fairing further comprises a top edge and an opposite bottom edge, and wherein, when the second elongated panel is attached to the second chassis fairing with the second mounting structure, the bottom edge of the second chassis fairing extends further than the bottom edge of the second elongated panel as measured along an axis that extends between the top edge of the second chassis fairing and the bottom edge of the second chassis fairing.

Clause 73. The aerodynamic underbody assembly of clause 71 or 72, wherein the first mounting structure comprises a first plurality of brackets attachable in spaced-apart relation between the first elongated panel and the first chassis fairing, and wherein the second mounting structure comprises a second plurality of brackets attachable in spaced-apart relation between the second elongated panel and the second chassis fairing.

Clause 74. The aerodynamic underbody assembly of any of clauses 71-73, wherein the first plurality of brackets are interconnected by a first plurality of elongated connecting structures, the first plurality of elongated connecting structures attached along the first surface of the first chassis fairing, and wherein the second plurality of brackets are interconnected by a second plurality of elongated connecting structures, the second plurality of elongated connecting structures attached along the first surface of the second chassis fairing.

Clause 75. The aerodynamic underbody assembly of any of clauses 71-74, wherein each one of the first plurality of brackets is a tri-lateral bracket comprising three points of attachment that includes one point of attachment for the first elongated panel and two points of attachment for the first plurality of elongated connecting structures, and wherein each one of the second plurality of brackets is a tri-lateral bracket comprising three points of attachment that includes one point of attachment for the second elongated panel and two points of attachment for the second plurality of elongated connecting structures.

Clause 76. The aerodynamic underbody assembly of any of clauses 71-75, wherein the first mounting structure has a higher degree of stiffness than the first elongated panel and the first chassis fairing, and wherein the second mounting structure has a higher degree of stiffness than the second elongated panel and the second chassis fairing.

Clause 77 A method of assembling an aerodynamic underbody assembly on a chassis that includes a first chassis fairing mount located on a first side of the chassis and a second chassis fairing mount located on a second side of the chassis, the method comprising attaching a first chassis fairing to the first chassis fairing mount, the first chassis fairing comprising a first surface and an opposite-facing second surface; attaching a second chassis fairing to the second chassis fairing mount, the second chassis fairing comprising a first surface and an opposite-facing second surface; attaching a first mounting structure to at least the first surface of the first chassis fairing; attaching a second mounting structure to at least the first surface of the second chassis fairing; attaching a first elongated panel to the first mounting structure, the first elongated panel having a first panel-end, a second panel-end opposite from the first panel-end, a first panel-side, a second panel-side opposite from the first panel-side, a bottom edge, and a top edge opposite from the bottom edge; and attaching a second elongated panel to the second mounting structure, the second elongated panel having a first panel-end, a second panel-end opposite from the first panel-end, a first panel-side, a second panel-side opposite from the first panel-side, a bottom edge, and a top edge opposite from the bottom edge, wherein the first elongated panel and the first chassis fairing attached with the first mounting structure extend substantially in parallel, and wherein the second elongated panel and the second chassis fairing attached with the second mounting structure extend substantially in parallel.

Clause 78. The method of clause 77, wherein the first mounting structure comprises a first plurality of brackets that are interconnected by a first plurality of elongated connecting structures that attach along the first surface of the first chassis fairing, and wherein the second mounting structure comprises a second plurality of brackets that are interconnected by a second plurality of elongated connecting structures that attach along the first surface of the second chassis fairing.

Clause 79. The method of clause 77 or 78, wherein the first elongated panel is shorter than the first chassis fairing along a lengthwise direction, wherein the second elongated panel is shorter than the second chassis fairing along a lengthwise direction, and wherein a bottom edge of the first chassis fairing and a bottom edge of the second chassis fairing extend further than the bottom edge of the first elongated panel and the bottom edge of the second elongated panel measured perpendicularly from a common horizontal plane extending across the chassis.

Clause 80. The method of any of clauses 77-79, wherein the first mounting structure has a higher degree of stiffness than the first elongated panel and the first chassis fairing, and wherein the second mounting structure has a higher degree of stiffness than the second elongated panel and the second chassis fairing.

In some embodiments, this disclosure may include the language, for example, “at least one of [element A] and [element B].” This language may refer to one or more of the elements. For example, “at least one of A and B” may refer to “A,” “B,” or “A and B.” In other words. “at least one of A and B” may refer to “at least one of A and at least one of B,” or “at least either of A or B.” In some embodiments, this disclosure may include the language, for example. “[element A], [element B], and/or [element C].” This language may refer to either of the elements or any combination thereof. In other words, “A, B, and/or C” may refer to “A,” “B,” “C,” “A and B,” “A and C,” “B and C,” or “A, B, and C.” In addition, this disclosure may use the term “and/or” which may refer to any one or combination of the associated elements.

The subject matter of this disclosure has been described in relation to particular embodiments, which are intended in all respects to be illustrative rather than restrictive. In this sense, alternative embodiments will become apparent to those of ordinary skill in the art to which the present subject matter pertains without departing from the scope hereof. In addition, different combinations and sub-combinations of elements disclosed, as well as use and inclusion of elements not shown, are possible and contemplated as well.

1. An underbody assembly for a vehicle, comprising:
an elongated panel configured to be coupled to a mounting structure that is configured to be coupled to an underbody of the vehicle such that the elongated panel is positioned between wheels located on a first side of the vehicle and wheels located on a second side of the vehicle.

2. The underbody assembly of claim 1, wherein the vehicle includes a front set of wheels and at least one set of rear wheels, and wherein the elongated panel extends from a first location proximal to the front set of wheels, to a second location proximal to the at least one set of rear wheels.

3. The underbody assembly of claim 2, wherein the elongated panel is positioned between the front set of wheels, and the at least one set of rear wheels.

4. The underbody assembly of claim 1, wherein the elongated panel comprises a length between about 0.15 meters and about 3 meters, a height between about 0.05 meters and about 0.8 meters, and a width of about 0.01 meters to about 0.1 meters.

5. The underbody assembly of claim 1, wherein the elongated panel is a single piece.

6. The underbody assembly of claim 1, wherein the elongated panel comprises a plurality of panel portions, and wherein the plurality of panel portions assembled together comprise a length of the elongated panel.

7. The underbody assembly of claim 6, wherein the plurality of panel portions assembled together include a first panel portion and a second panel portion that are spaced apart by a gap.

8. The underbody assembly of claim 1, wherein the elongated panel is positioned at an angle with respect to a vertical axis that extends between a surface that the vehicle rests on and a top of the vehicle.

9. The underbody assembly of claim 8, wherein the angle is 0° to 90°, inclusive, and wherein the elongated panel is positioned substantially parallel to the vertical axis when the angle is 0°.

10. The underbody assembly of claim 9, wherein the angle is 0°.

11. The underbody assembly of claim 1, wherein the vehicle includes at least one power source for propelling the vehicle, and wherein the elongated panel is positioned below the at least one power source, such that the elongated panel is positioned between the ground and the at least one power source.

12. The underbody assembly of claim 11, wherein the at least one power source is a tank configured for storing a fluid.

13. The underbody assembly of claim 12, wherein the vehicle has two power sources configured for storing the fluid, the two power sources being a first tank positioned proximal to the wheels located on the first side of the vehicle, and a second tank positioned proximal to the wheels located on the second side of the vehicle, and wherein the elongated panel is positioned substantially between the first tank and the second tank.

14. The underbody assembly of claim 12, wherein the fluid comprises gasoline, diesel fuel, hydrogen, or natural gas.

15. The underbody assembly of claim 11, wherein the at least one power source comprises one or more batteries configured to power an electric powertrain associated with the vehicle.

16. The underbody assembly of claim 15, wherein the mounting structure is coupled to:
the one or more batteries, and/or
one or more structures that mount the one or more batteries on the vehicle.

17. The underbody assembly of claim 1, wherein the mounting structure is coupled to a chassis frame rail of the vehicle.

18. The underbody assembly of claim 1, wherein the mounting structure is coupled to a fairing.

19. The underbody assembly of claim 1, further comprising two or more of the elongated panels.

20. The underbody assembly of claim 19, wherein the two or more elongated panels are substantially parallel to each other.

21. The underbody assembly of claim 19, wherein the two or more elongated panels extend different distances from the underbody of the vehicle, such that at least one elongated panel is closer to the ground as compared to another elongated panel.

22. A vehicle, comprising:
the underbody assembly of claim 1.

23. The vehicle of claim 22, wherein the underbody assembly is a first underbody assembly, and wherein the vehicle comprises a second underbody assembly comprising at least one additional elongated panel configured to couple to another mounting structure on the underbody of the vehicle, such that the at least one additional elongated panel is positioned proximal to rear wheels of the vehicle and extends further toward a rear of the vehicle.

24. The vehicle of claim 23, wherein the rear wheels are drive wheels of the vehicle.

25. The vehicle of claim 22, wherein the vehicle is a tractor capable of being removably coupled to a trailer.

26. A method of mounting an aerodynamic underbody structure on a vehicle, the method comprising:
coupling an elongated panel to a mounting structure; and
coupling the mounting structure to an underbody of the vehicle, such that the elongated panel extends between wheels located on a first side of the vehicle and wheels located on a second side of the vehicle.

27. The method of claim 26, wherein the mounting structure is coupled to the underbody before the elongated panel is coupled to the mounting structure, or wherein the elongated panel is coupled to the mounting structure before the mounting structure is coupled to the underbody.

28. The method of claim 26, wherein the underbody comprises a chassis frame rail, and wherein the mounting structure is coupled to at least the chassis frame rail.

29. The method of claim 26, wherein the underbody comprises an externally-mounted fairing, and wherein the mounting structure is coupled to at least the externally-mounted fairing.

30. The method of claim 26, wherein a power supply is attached to, and supported under, the underbody, and wherein the mounting structure is coupled to the power supply.

31. The method of claim 26, wherein the elongated panel comprises one of a pair of elongated panels that couple in spaced-apart relation between the wheels on the first side and the wheels on the second side, such that the pair of elongated panels are substantially parallel to each other.

32. The method of claim 26, wherein the elongated panel comprises one of a pair of elongated panels that are mounted in spaced-apart relation between the wheels on the first side and the wheels on the second side, such that the pair of elongated panels are positioned at an angle relative to each other.

33. The method of claim 31, wherein the pair of elongated panels are different lengths.

34. The method of claim 31, wherein the pair of elongated panels couple to the underbody such that each extends a different distance from the underbody.
